(19) United States
(12) Patent Application Publication
(10) Pub. No.: US 2016/0088326 A1
(43) Pub. Date: Mar. 24, 2016

(54) DISTRIBUTED RECORDING, MANAGING, AND ACCESSING OF SURVEILLANCE DATA WITHIN A NETWORKED VIDEO SURVEILLANCE SYSTEM

(71) Applicant: Watchcorp Holdings LLC, Nashville, TN (US)

(72) Inventors: Viorel SOLOMON, Thornhill (CA); Timothy Salzman, Bayport (CA); Christina Fiore, Nashville, TN (US)

(21) Appl. No.: 14/863,071

(22) Filed: Sep. 23, 2015

Related U.S. Application Data
(60) Provisional application No. 62/054,246, filed on Sep. 23, 2014.

(51) Int. Cl. H04N 21/254; H04N 21/443; H04N 7/18; H04N 21/442; H04N 21/2187

(52) U.S. Cl. CPC H04N 21/254; H04N 21/44218; H04N 21/2187; H04N 7/181; H04N 21/4437

(57) ABSTRACT

A method for recording and distributing surveillance data within a networked video surveillance system includes dynamically allocating one or more virtual application servers executing within a server pool on one or more physical host systems to a plurality of local surveillance domains, establishing a respective connection between a corresponding network node within each local surveillance domain and the virtual application server allocated to the local surveillance domain over a network, and receiving one or more live video streams captured by one or more video sources within each local surveillance domain and transmitted from the corresponding network node of the local surveillance domain via the respective connection to the virtual application server allocated to the local surveillance domain.

### CROSS REFERENCE TO RELATED APPLICATIONS

This application claims the benefit of U.S. Provisional Patent Application Ser. No. 62/054,246, filed Sep. 23, 2014, the contents of all incorporated herein in their entirety by reference thereto.

### BACKGROUND OF THE INVENTION

Exemplary embodiments of the present invention relate to scalable video surveillance systems that do not require a permanent installation in terms of the locations and numbers of video cameras. More specifically, exemplary embodiments relate to such systems that provide cloud-based video surveillance services to provide for remote viewing of live video streams and recorded video and still image data from a network-connected device such as a desktop computer, a smartphone, or a tablet.

Video surveillance systems are increasingly being used both commercially and privately to monitor areas for security purposes. Within the field of video surveillance systems, networked video surveillance technologies are now being used. Network video surveillance systems can be used to view and record image data captured from local or remote networked video cameras and can be used for a wide variety of purposes. For example, such networked viewing and recording systems can be used for supervision purposes and for security in the surveillance of buildings and vehicles.

Unlike conventional closed circuit television (TV) systems, networked video surveillance systems make use of standard network infrastructures, such as Internet Protocol (IP) based network infrastructures, to carry digital video signals and control signals. One advantage of networked video surveillance systems is that they allow video surveillance to be performed over existing networks such as the internet, IP based local area networks (LANs), or IP-based virtual private networks (VPNs) running on top of a public network such as the internet.

Typically, a networked video surveillance system comprises one or more storage servers that receive data from one or more video camera servers distributed on a computer network. Such a networked video surveillance system also typically comprises one or more viewing devices (for example, desktop computers and mobile devices), which can be used to view live video image data from the camera servers or stored video image data from the storage servers.

### SUMMARY OF THE INVENTION

Exemplary embodiments of the present invention are related to a method for recording and distributing surveillance data within a networked video surveillance system. The method includes dynamically allocating one or more virtual application servers executing within a server pool on one or more physical host systems to a plurality of local surveillance domains, establishing a respective connection between a corresponding network node within each local surveillance domain and the virtual application server allocated to the local surveillance domain over a network, and receiving one or more live video streams captured by one or more video sources within each local surveillance domain and transmitted from the corresponding network node of the local surveillance domain via the respective connection to the virtual application server allocated to the local surveillance domain.

Exemplary embodiments of the present invention that are related to data processing systems and computer apparatuses corresponding to the above-summarized method are also described and claimed herein.

The above-described and other features and advantages realized through the techniques of the present disclosure will be better appreciated and understood with reference to the following detailed description, drawings, and appended claims. Additional features and advantages are realized through the techniques of the present invention. Other embodiments and aspects of the invention are described in detail herein and are considered a part of the claimed invention.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a schematic diagram illustrating an example network architecture for a networked surveillance system environment supporting distributed control of surveillance video and still image data;

FIG. 2 is a block diagram illustrating a virtual application server in accordance with an exemplary embodiment of the present invention;

FIG. 3 is a block diagram illustrating an example configuration of a local surveillance domain that may be implemented within exemplary networked surveillance system environment of FIG. 1; and

FIG. 4 is a block diagram of an exemplary computer system that can be used for implementing exemplary embodiments of the present invention.

The detailed description explains exemplary embodiments of the present invention, together with advantages and features, by way of example with reference to the drawings, in which similar numbers refer to similar parts throughout the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered to be within the scope of the claimed invention.

### DETAILED DESCRIPTION

While the specification concludes with claims defining the features of the invention that are regarded as novel, it is believed that the invention will be better understood from a consideration of the description of exemplary embodiments in conjunction with drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form, and it will be apparent to those skilled in the art that the present invention may be practiced without these specific details. Further, the terms and phrases used herein are not intended to be limiting but rather to provide an understandable description of the invention.

Exemplary embodiments of a networked video surveillance system in accordance with the present invention will now be described with reference to the drawings. Exemplary embodiments of the present invention may be implemented to provide a distributed and/or cloud-based video surveillance system that offers services for remote storage and remote viewing of recorded and real-time surveillance data collected by a plurality of video sources arranged in a desired configuration within a remote surveillance domain (such as, for example, a commercial or residential surveillance site). In this regard, exemplary embodiments can be implemented to provide mechanisms for enabling one or more of relaying, recording, processing, storage, analysis, live viewing, playback, logging, and event-monitoring of streaming video and still image data collected by a plurality of video sources of a video surveillance domain, as well as for remote management of the video sources.

Exemplary embodiments may further be implemented to provide a mechanism for management of large amounts of video surveillance data in a manner that is efficient, reliable, and scalable and does not require a permanent installation in terms of the locations and numbers of video sources within a surveillance domain, and exemplary embodiments can be implemented based on a network architecture that is designed to allow for example video surveillance domains to be dynamically reconfigured and expanded seamlessly without creating integration problems and to utilize virtualization techniques to be highly-available, flexible, scalable, and cost-effective. More particularly, exemplary embodiments can be implemented to provide a centralized and/or cloud-based surveillance data and management server system that utilizes secure computer network connections with high network bandwidth capacity to receive streaming video and still image data from a plurality of video sources. Each video source is within each of a plurality of remote surveillance domains, which store and manage the received surveillance data on one or more media storage servers without any need for networked video recorders, and provides services allowing authorized end users to securely access the surveillance data server system via remotely-connected, network-enabled client devices and receive live streaming video and access to, searching, and streaming of stored video and still image data.

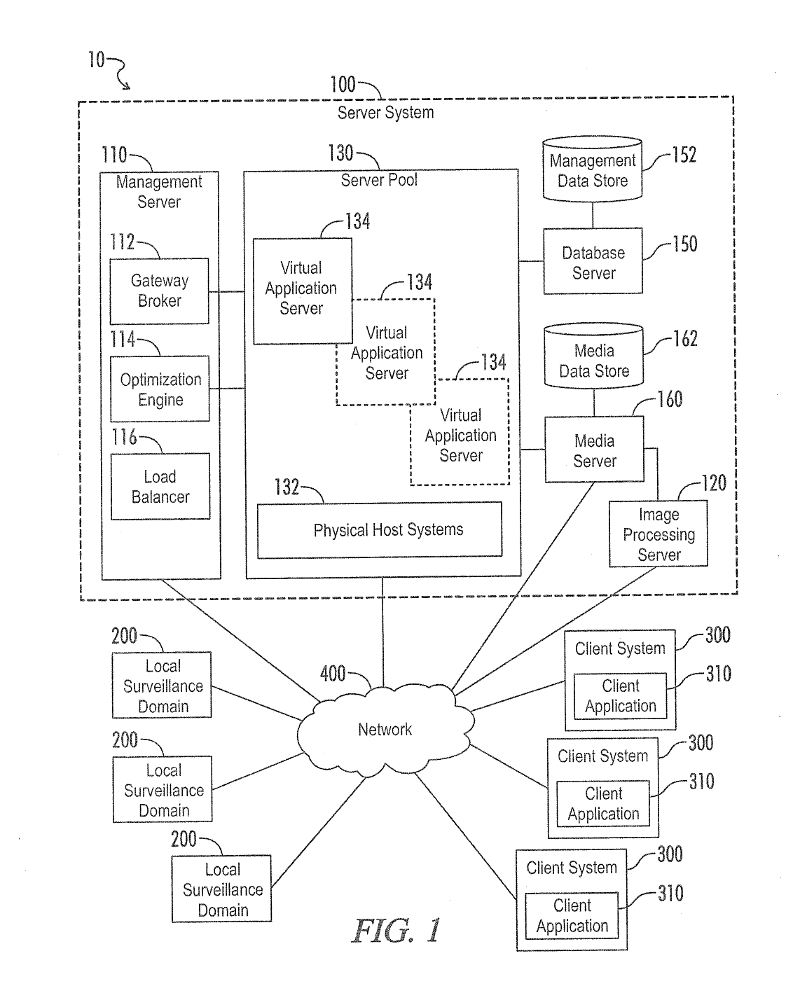

Referring now to FIG. 1, a schematic diagram illustrating an example network architecture for a networked surveillance system environment 10 supporting distributed management of surveillance video and still image data is provided. It should of course be understood that FIG. 1 is intended as an example, not as an architectural limitation for different embodiments of the present invention, and, therefore, the particular elements depicted in FIG. 1 should not be considered limiting with regard to the environments within which exemplary embodiments of the present invention may be implemented. In the example illustrated in FIG. 1, environment 10 is implemented as a client/server environment that includes a surveillance data and management server system 100 providing a set of surveillance data and management services that are accessed on a surveillance side from a plurality of local surveillance domains 200 that are operatively coupled to the server system via a communication network 400 and a set of user services that are accessed on a user side by end users of the system through operation of any of a plurality of client systems 300 that are operatively coupled to the server system via the communication network 400.

In exemplary embodiments, network 400 can be configured to facilitate communications between server system 100 and client systems 300, between server system 100 and devices within local surveillance domains 200, and communications with and between other devices and computers connected together within environment 10, by any suitable wired (including optical fiber), wireless technology, or any suitable combination thereof, including, but not limited to, personal area networks (PANs), local area networks (LANs), wireless networks, wide-area networks (WAN), the internet (a network of heterogeneous networks using the Internet Protocol, IP), and virtual private networks. The network may also utilize any suitable hardware, software, and firmware technology to connect devices such as, for example, optical fiber, Ethernet, ISDN (Integrated Services Digital Network), T-1 or T-3 link, FDDI (Fiber Distributed Data Network), cable or wireless LMDS network, Wireless LAN, Wireless PAN (for example, IrDA, Bluetooth, Wireless USB, Z-Wave and ZigBee), HomePNA, Power line communication, or telephone line network. Such a network connection can include intranets, extranets, and the Internet, may contain any number of network infrastructure elements including routers, switches, gateways, etc., can comprise a circuit switched network, such as the Public Service Telephone Network (PSTN), a packet switched network, such as the global Internet, a private WAN or LAN, a cellular telecommunications network, a broadcast network, or a point-to-point network, and may utilize a variety of networking protocols now available or later developed including, but not limited to the Transmission Control Protocol/Internet Protocol (TCP/IP) suite of protocols for communication.

It will be appreciated that the particular architecture depicted in FIG. 1 is provided as an example for illustrative purposes and should be considered non-limiting. For example, although FIG. 1 represents a particular number of local surveillance domains 200 and client systems 300 for illustrative purposes, the number of such domains and devices could vary such that, in exemplary embodiments, any number of local surveillance domains and client systems may be connected to server system 100 at any given time via network 400, and the number of local surveillance domains and client systems may be much larger. Moreover, in exemplary embodiments, environment 10 can include additional servers and other devices not shown in FIG. 1, and server system 100 can comprise multiple server components and databases located within a single server system or within multiple server systems, where the multiple server systems are integrated with or accessible through components of local surveillance domains 200 and/or client systems 300 as a distributed server system via network 400.

In the present exemplary embodiment, server system 100 generally includes a management server 110, an image processing server 120, a central application server pool 130 that includes one or more virtual application servers 134 realized on one or more physical host systems 132, a database server 150 that is coupled to a management data store 152, and a media server 160 that is connected to a media data store 162. Management server 110 includes a gateway broker 112, an optimization engine 114, and a load balancer 116. As will be described in greater detail below, management server 110 is configured to facilitate, for local surveillance domains 200 and client systems 300, access to services provided by a plurality of virtual application servers 134 executing within server pool 130 and to monitor and dynamically manage a quantity and performance of the virtual application servers that are invoked within server pool 130.

In exemplary embodiments, management server 110, image processing server 120, central application server pool 130, database server 150, media server 160, and any other servers and components thereof employed within server system 100 and third-party servers utilized within exemplary environment 10 can be implemented within any suitable computing system or systems such as a workstation computer, a mainframe computer, a server system (for example, workstations running the Microsoft Servers line of software and technology, IBM RS/6000 workstations and servers running the AIX operating system, or an IBM zSeries eServer running z/OS, z/VM, or LINUX OS), a server cluster, a distributed computing system, a cloud based computing system, or the like, as well as any of the various types of computing systems and devices described below with reference to client systems 300. Server system 100 may be implemented using any of a variety of architectures. For example, the various server and database components of server system 100 may also be implemented independently or within a single, integrated device. While the exemplary embodiment illustrated in FIG. 1 depicts various individual components, the functionalities provided by these components, or various combinations of these functionalities, may actually be functionalities executing on separate physical devices and/or virtual machines. In this regard, server system 100 may comprise a number of computers connected together via a network and, therefore, may exist as multiple separate logical and/or physical units, and/or as multiple servers acting in concert or independently, wherein each server may be comprised of multiple separate logical and/or physical units. In exemplary embodiments, server system 100 can be connected to network 400 through a collection of suitable security appliances, which may be implemented in hardware, software, or a combination of hardware and software.

As one example, server system 100, or various components thereof, may be implemented as a scalable cloud computing system hosted within one or more physical devices and/or virtual machines of a cloud computing infrastructure provided by a cloud provider on the internet. Such a cloud computing system can benefit from and utilize a number of features that may be available within such an infrastructure, such as high-capacity networks, low-cost computing and storage resources, automatic failure recovery, and scalability and elasticity of the underlying computer and storage resources for the application software and database components of server system 100 that can allow for the services to automatically scale on-demand to match application demand. As another example, although FIG. 1 represents a single management server 110, a single image processing server 120, a virtual application server pool 130, etc. For illustrative purposes, it will be appreciated that there may variously be multiple management servers 110, multiple image processing servers 120, multiple virtual application server pools 130, etc., to provide redundancy and/or additional capacity.

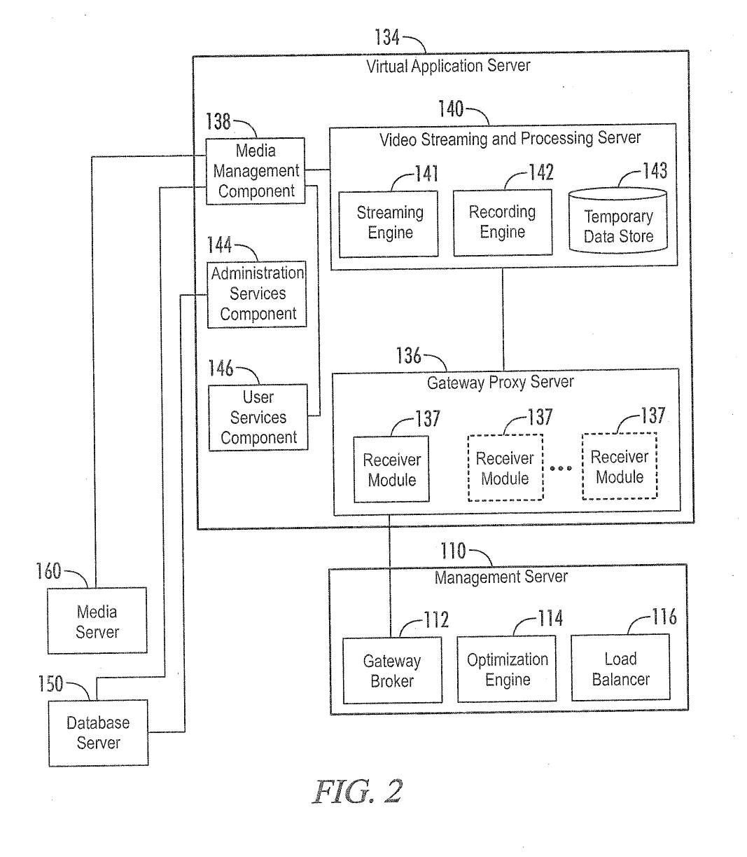

A block diagram illustrating an exemplary embodiment of a virtual application server 134 that may be invoked and execute within central application server pool 130 is provided in FIG. 2. In general, exemplary virtual application server 134 includes a gateway proxy server 136 that is communicatively coupled to gateway broker 112 and within which one or more receiver modules 137 are invoked and executing therewithin (as described in greater detail below), a video streaming and processing server 140 that is in communication with gateway proxy server 136, a media management component 138 that is in communication with database server 150, media server 160, and video streaming and processing server 140, an administration services component 144 that is in communication with database server 150, and a user services component 146 that is in communication with the media management component. As further illustrated in FIG. 2, video streaming and processing server 140 includes a streaming engine 141, and a recording engine 142, and a temporary data store 143.

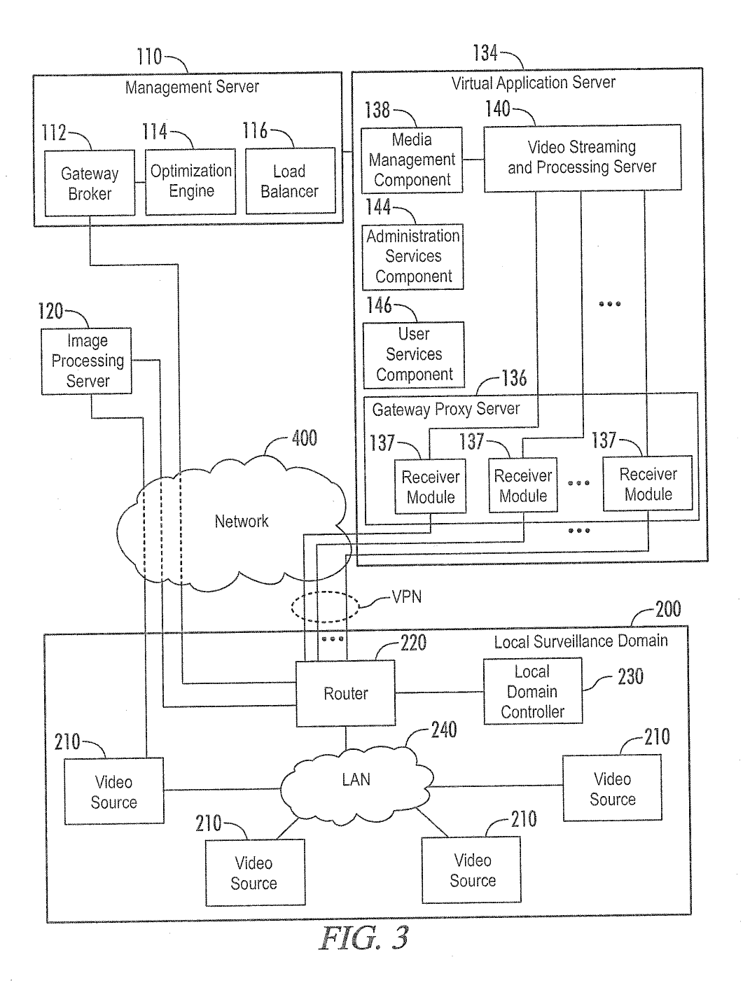

Referring now to FIG. 3, a block diagram illustrating an exemplary embodiment of a local surveillance domain 200 is provided. In general, a local surveillance domain is associated with and configured for an entity (such as a business, public agency, property owner, or tenant) to collect surveillance video and still image data from one or more video sources located at a property or site under surveillance on behalf of the associated entity. As illustrated in FIG. 3, local surveillance domain 200 includes a plurality of video sources 210, a router 220, and a local domain controller 230 communicatively coupled to the router. Router 220 is connected to server system 100 via network 400, thereby providing a mechanism for local controller to communicate with the server system over network 400, and is also connected to video sources 210 via a local area network (LAN) 240, capable of receiving multiple streaming video streams output from the video sources via the LAN, and capable of streaming multiple video streams simultaneously over network 400.

In exemplary embodiments, video sources 210 may comprise any device(s) configured to capture video and/or images (in the form of surveillance footage) and may be further configured to transmit captured video and/or images. Thus, video sources 210 may comprise the devices which perform the initial optical capture of video and still images, may be intermediate video transfer devices, or may be another type of video transmission device. Each video source 210 may be configured to provide one or more types of data, including at least one channel of streaming video data (and optionally audio data), video image snapshots, data pertaining to an operational status of the device, and event notifications, such as, for example, motion detected within the surveillance footage. In cases where audio data is captured, audio will be considered part of the video data transmission. In exemplary embodiments, video sources 210 may be conventional video cameras, still cameras, internet protocol (IP) cameras, video switches, video buffers, video servers, or other video capture or transmission devices, including combinations thereof. In one example, a video source 210 may comprise a conventional camera coupled to a video streaming unit configured to convert a captured video signal into a format suitable for IP streaming and transmit the converted streaming video signal and other data to router 220 via LAN 240. In another example, a video source 210 may comprise an IP camera configured to capture and compress a continuous video image into a streaming video format, such as but not limited to, MJPEG or h.264, and transmit the streaming video signal and other data to router 220 via LAN 240 using, for example, the Real-Time Streaming Protocol (RTSP), Real-time Transport Protocol (RTP), or User Datagram Protocol (UDP), although other protocols and variations thereof may be employed in different embodiments. Exemplary embodiments may support resolutions from low resolution to very high definition (HD), depending on the capabilities of video sources 210.

In the present exemplary embodiment, router 220 is configured to receive the streaming video signals from connected video sources 210 and, under the control of local controller 230, transmit each of the received streaming video signals to server system 100 via a respective logical communication link established over network 400 for the streaming video signal. In particular, local controller 230 is configured to monitor an operating state of router 220, including the particular video sources of the plurality of video sources 210 that are connected and streaming video data to router 220 at any given time, and communicate with gateway broker 112 on behalf of the router. More specifically, upon a disconnected router 220 powering up or otherwise being activated or coming to an online state, local controller 230 is configured to automatically detect the online status of the router and further detect which of video sources 210 are connected and streaming video data to the router. Local controller 230 then transmits a connection request via network 400 to gateway broker 112 that includes a notification that router 220 has become operative along with an indication of the quantity of video sources 210 that are presently connected to and transmitting streaming video to the router. Upon receiving the connection request from local controller 230, gateway broker 112 notifies optimization engine 114 that a local surveillance domain has become activated and is ready to transmit streaming video data to server system 100. This notification also specifies the indicated quantity of video sources 210 that are presently connected to and transmitting streaming video data to router 220. In exemplary embodiments in which one or more video sources will be utilized to transmit multiple video streams, local controller 230 can be configured to further specify a quantity of video streams that are being transmitted by each video source to router 220.

In the present exemplary embodiment, optimization engine 114 is configured to perform monitoring and management of virtual application servers 134 within server pool 130. In particular, optimization engine 114 is configured to collect, manage, and monitor system state and performance information regarding the virtual application servers 134 executing within server pool 130, to provision virtual application servers 134 within server pool 130 for execution on an as-needed basis in cooperation with physical host systems based on the collected performance information and present demand for resources (for instance, a quantity of presently connected local surveillance domains 200 and a quantity of video sources presently supplying streaming video data from the connected local surveillance domains for each virtual application server instance), and to direct workload consolidation, perform failure detection, and direct recovery and migration operations for the virtual application servers executing within the server pool. In exemplary embodiments, the various monitoring and management operations performed by optimization engine 114 can be variously performed according to a predetermined schedule and/or triggered based on predetermined events.

For example, referring again to FIG. 3, optimization engine 114 is configured to, upon receiving a notification from gateway broker 112 that a local surveillance domain has become activated and is ready to transmit streaming video data to server system 100, perform an analysis of the state and performance information of the executing virtual application servers 134 to determine whether any of the presently executing virtual application servers has sufficient availability to be allocated to the newly-activated local surveillance domain and handle the streaming video data that will be transmitted from video sources 210 presently connected within the local surveillance domain. If optimization engine 114 identifies a virtual application server that is presently executing within server pool 130 as having sufficient availability, the optimization server allocates the identified virtual application server to the local surveillance domain, and replies to the notification from gateway broker 112 with an indication of the identified virtual application server. On the other hand, if optimization engine 114 determines that none of the virtual application servers that are presently executing within server pool 130 have sufficient availability, the optimization server provisions and invokes a new virtual application server within the server pool, allocates the newly-invoked virtual application server to the local surveillance domain, and replies to the notification from gateway broker 112 with an indication of the allocated virtual application server.

Upon receiving the indication or identification of the virtual application server that has been allocated to the local surveillance domain from optimization engine 114, gateway broker 112 transmits an acknowledgment message to the local controller from which the gateway broker received the connection request that includes information regarding the allocated virtual application server. This information may include, for example, a virtual IP address for gateway proxy server 136 of the allocated virtual application server 134. In response to receiving the acknowledgment message from gateway broker 112, local controller 230 utilizes the information regarding the allocated virtual application server to configure a virtual private network (VPN) over network 400 to provide a secure connection for communication between router 220 and gateway proxy server 136 for transmitting video streams from local surveillance domain 200 to server system 100 to keep the transferred data private from other devices which have access to network 400 and the equipment used to perform the transfer of streaming video data. Upon configuring the VPN over network 400 between router 220 and gateway proxy server 136 of the allocated virtual application server, local controller 230 replies to the acknowledgment message by transmitting a request to gateway broker 112 to establish a logical connection over the network configured as a VPN between the router and the gateway proxy server for each video stream being supplied from a video source within local surveillance domain 200. The information within this request can include, for example, an indication of a respective port within router 220 that is being utilized for relaying each video stream supplied from a video source, a unique identifier of each connected video source (for example, a universally unique identifier (UUID)), and, if any video source is configured to transmit more than one video stream, a unique identifier of each video stream, and/or any other information that is suitable to be utilized by the allocated virtual application server to establish a respective logical connection with the router 220 for each video stream.

Upon receiving this request from local controller 230, gateway broker 112 provides the relevant connection information included within the request to gateway proxy server 136 within the allocated virtual application server and directs the gateway proxy server to invoke a respective receiver module 137 within gateway proxy server 136 for receiving each video stream supplied from each video source and relayed by router 220 at server system 100 based on the information included in the request and establish a new logical connection between the respective receiver module 137 for each video stream and the router 220 over the VPN configured within network 400 for local surveillance domain 200 based on the corresponding connection information. Each receiver module 137 includes an interface for receiving a video stream and an interface for transmitting a video stream. Upon the respective logical connection between router 220 and a respective receiver module 137 being established for each video stream in this manner, the router can thereby begin concurrently transmitting the video streams received from video sources 210 to the corresponding receiver modules 137 over the network 400 configured as a trusted VPN connection to server system 100 using, for example, RTSP or any other network control protocol suitable for use in controlling transmission of streaming media, and gateway proxy server 136 can then receive the streaming video data from the router via the respective receiver modules and concurrently pass the received video streams to video streaming and processing server 140. The manner in which video streaming and processing server 140 is configured to handle streaming video signals received from receiver modules of gateway proxy server 136 will be described in detail below. Data indicative of the video source identifier and, if necessary, the video stream identifier can be included with the data being streamed from the video source to allow for components of server system 100 to be able to uniquely identify the video source from which a given stream originates or uniquely identify the particular video stream. Alternatively, an indication of a respective port within router 220 that is being utilized for relaying each video stream supplied from a video source can be utilized for components of server system 100 to be able to uniquely identify the video source from which a given stream originates or uniquely identify the particular video stream.

In exemplary embodiments, gateway proxy server 136 can be further configured to monitor each connection between a respective receiver module executing therewithin and a router within a local surveillance domain that is connected to the virtual application server for the gateway proxy server. Gateway proxy server 136 can be further configured to, upon discovering that a connection between a receiver module and a connected router for a particular video source transmitting streaming video data has been lost, automatically attempt to re-establish the corresponding connection between the receiver module and router. If gateway proxy server 136 is unable to re-establish the connection (for example, after a predetermined time period or a predetermined number of attempts to reconnect), the gateway proxy server can terminate the respective receiver module for the lost connection and transmit a notification of the lost connection via the network connection with router 220 to local controller 230, effectively handing off duties for re-establishing the connection to the local controller (thereby preserving resources at server system 100, as it is more likely that, if the gateway proxy server is unable to re-establish the connection, the issue resulting in the lost connection manifested within the local surveillance domain). Likewise, gateway proxy server 136 can be also configured to, upon discovering that a connection with a connected router for a local surveillance domain has been lost, attempt to re-establish the connection with the router. If gateway proxy server 136 is unable to re-establish the connection with the router (for example, after a predetermined time period or a predetermined number of attempts to reconnect), the gateway proxy server can terminate the respective receiver modules executing therewithin for receiving streaming video data from the router with which the connection has been lost and transmit a notification of the lost connection with the local surveillance domain to management server 110 so that optimization engine 114 is aware that the virtual application server for the gateway proxy server is not presently being utilized for handling streaming video data from the local surveillance domain for the disconnected router.

In exemplary embodiments, local controller 230 can also be configured to, upon the logical connections between router 220 and corresponding receiver modules 137 within the gateway proxy server of the virtual application server allocated to local surveillance domain 200 being established as described above, automatically detect which of video sources 210 are connected and streaming video data to router 220 at any given time. As the number of video sources connected to the router may change over time (for example, video sources may be added to and removed from local surveillance domain), local controller 230 is configured to detect each time a new video source connects to router 220 to transmit streaming data to the router and each time a video source transmitting streaming video data is disconnected from the router or otherwise stops transmitting streaming video data to the router.

More specifically, local controller 230 can be configured to, upon detecting that a new video source has connected to router 220 or that a disconnected video source has reconnected to the router to transmit streaming video data, transmit a request to gateway broker 112 to establish a logical connection over the network configured as a VPN between the router and the gateway proxy server 136 for each video stream being supplied from the newly-connected video source within local surveillance domain 200. Upon receiving this request from local controller 230, gateway broker 112, in addition to notifying optimization engine 114 of the additional logical connection for receiving streaming video data being established at the corresponding virtual application server, provides the relevant connection information included within the request to gateway proxy server 136 within the virtual application server and directs the gateway proxy server to invoke a respective receiver module 137 within gateway proxy server 136 for receiving each video stream supplied from the newly-connected video source and relayed by router 220 at server system 100 based on the information included in the request and establish a new logical connection between the respective receiver module 137 for each video stream and the router 220 over the VPN configured within network 400 for local surveillance domain 200 based on the corresponding connection information. Upon the respective logical connection being established for each video stream in this manner, router 220 can thereby begin transmitting each video stream received from the newly-connected video source 210 to the corresponding receiver modules 137 over the network 400 configured as a trusted VPN connection to server system 100, and gateway proxy server 136 can then receive the streaming video data from the router via the respective receiver modules and pass the streaming video data to video streaming and processing server 140.

Similarly, local controller 230 can be further configured to, upon discovering that a particular video source transmitting streaming video data has disconnected from router 220 or has otherwise stopped transmission of a video stream to the router, transmit a notification of such to gateway broker 112 over network 400, in response to which the gateway broker can, in addition to notifying optimization engine 114 of the loss of the streaming video data connection at the corresponding virtual application server, transmit a request to gateway proxy server 136 to terminate the respective receiver module that was invoked for receiving each video stream that was being transmitted by the video source, thereby also terminating the corresponding logical connection between the router and the gateway proxy server. In this manner, a one-to-one correspondence is dynamically maintained between receiver modules 137 executing within gateway proxy server 136 and video sources 210 that are actively transmitting streaming video data to router 220 (or active video streams being transmitted from the video sources to the router) within local surveillance domain 200. Moreover, upon a video source becoming newly-connected (or reconnected) to router 220 at a point in time after logical connections between the router and corresponding receiver modules 137 within the gateway proxy server of the virtual application server allocated to local surveillance domain 200 have already been established, a new logical connection for each video stream supplied from the subsequently-connected video source can be established between the router and a respective receiver module within the gateway proxy server without disruption of the already established logical connections. Similarly, upon a video source becoming disconnected from router 220, the respective receiver module and the corresponding logical connection established for each video stream that was supplied by the disconnected video source can be terminated without disruption of the established logical connections between the router 220 and the gateway proxy server for the other connected video sources within local surveillance domain 200.

With further reference to FIG. 3, in exemplary embodiments, one or more of video sources 210 within local surveillance domain 200 may be further configured to capture still or static images for transmission from the local surveillance domain to image processing server 120 via a connection over network 400. The connection between local surveillance domain 200 and image processing server 120 for transmitting still images captured by such a video source may be established, for example, directly between the particular video source and the image processing server (for instance, where the video source is an IP camera), between a network device that is communicatively coupled to the video source and the image processing server (for instance, a network-capable device that is utilized to transmit video streaming data from the video source to router 220 via LAN 240), or between router 220 and the image processing server, with the router operating under the control of local controller 230 to receive still images captured by the video source and transmitted over LAN 240, establish the connection with the image processing server, and relay the captured still images to the image processing server.

In exemplary embodiments, such a video source can be configured to sequentially capture still images for transmission to image processing server 120 according to a predetermined schedule. For example, the video source can be configured to utilize a clock component to capture a series of still images at specific intervals of time, such as every preset number of seconds, every hour, or every 6 hours. The still images captured by such a video source and transmitted to image processing server 120 can comprise static images in any suitable format such as, for example, the PNG, JPEG, GIF, WMF, and EMF formats. The particular node or component within local surveillance domain 200 that is employed to transmit the still images captured by a video source to image processing server 120 can be configured to transfer the still images, as well as any appropriate related data such as an identifier of the capturing video source, a timestamp for each captured image, and any detected environmental or event information relevant to the image, to image processing server via network 400 using, for example, the File Transfer Protocol (FTP), although other protocols and variations thereof may be employed in different embodiments. The manner in which image processing server 120 is configured to handle still images received from local surveillance domains will be described in detail below.

It will be understood that FIG. 3 is intended to represent an example local surveillance domains 200, that many other variations or permutations of local surveillance domains and local surveillance domain components are possible in addition to those explicitly disclosed herein, and that the respective configurations and implementation details may vary between the plurality of local surveillance domains included within exemplary environment 10. For instance, without limiting the generality of the foregoing, components can communicate via wired or wireless links, some components may be wired while others are wireless, the number and type of video sources may vary such that, in one example, a single local surveillance domain may include a mixture of analog and digital video cameras. As another example, local controller 230 may be implemented within a general purpose computer system or any of various types of digital devices, including portable and special-purpose devices, suitably programmed or configured to provide the functions described herein. Furthermore, local controller 230 need not be a single computer system or device. For example, local controller 230 may be implemented within router 220 or, alternatively, within a collection of devices that provide the necessary functionality and/or provide redundancy.

Referring again to the exemplary embodiment illustrated in FIG. 1, as shown, each virtual application server 134 executing within central application server pool 130 is commonly communicatively coupled to database server 150 and media server 160, and image processing server 120 is also communicatively coupled to media server 160. Database server 150 is connected to management data store 152, which comprises a plurality of databases that are maintained by database server 150, commonly accessed by virtual application servers 134 invoked within server pool 130 via database services provided at a front end by database server 150, and used to store a variety of sets of information on a variety of matters that are utilized in implementing the functions performed by and providing the services offered by the virtual application servers, as described below in greater detail. As used herein, the term “data store,” “data storage unit,” storage device“, and the like can to any suitable memory device that may be used for storing data, including manual files, machine-readable files, and databases.

As discussed below, the virtual application servers executing within server pool 130 at any given time can be configured to commonly access management database server 150 to maintain and access various types of information records within the plurality of databases of management data store 152. Each of the plurality of databases can comprise, for example, a structured relational database that includes one or more database tables, each of which is a data structure logically in the form of a table having multiple information records. An information record (which may also be referred to an entry or a table) may be, for example, a program and/or data structure that tracks various data related to a corresponding type of information record, with each information record having one or more (typically multiple) fields (also referred to as attributes). As used herein, the terms “data,” “content,” “information” and similar terms may be used interchangeably to refer to data capable of being captured, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

The plurality of databases that are maintained within management data store 152 via database server 150 can include, for example, a domain controlling entity database, a local surveillance domain database, a video source database, a user account database, a user groups database, and one or more additional databases that may be used for storing any other suitable information that may be utilized by server system 100 (for example, metadata characterizing the structure of the database and the data stored therein, system usage data, audit trail data, data used internally within the system by virtual application servers 134, and the like). Example implementations of such databases are described below. In exemplary embodiments, the various databases maintained within data store 152 can be maintained as groups within one or more larger databases or maintained individually.

As discussed above with reference to FIG. 3, each local surveillance domain 200 is associated with and configured for an entity (such as a business, public agency, property owner, or tenant) to collect surveillance video and image data from one or more video sources located at a property or site under surveillance on behalf of the associated entity. In this regard, such an entity may be associated with more than one local surveillance domain such that a plurality of local surveillance domains may be managed separately or collectively as a group for a single associated entity. When a local surveillance domain is initially configured for deployment within surveillance system environment 10, an initial set of information is established within management data store 152 for the domain according to the initial device configuration of the domain, user access rights for the domain and information that can be used during a user registration process to verify users that have been granted access rights, and other information defined by the associated controlling entity for the domain.

For example, the associated controlling entity can specify the domain as one of a plurality of local surveillance domains that are managed collectively within server system 100 or as a domain that is managed collectively, can define the users and the particular access rights for each user authorized to access the surveillance data supplied from the domain and manage the configuration of the domain and the various devices included therein, define particular groups of users and particular access rights that are granted to each group of users, and can define the particular conditions for access. In a typical situation, an associated controlling entity for a local surveillance will have unconditional access to management of the surveillance domain configuration and the corresponding surveillance data, while the access rights for other users may be conditional or unconditional access. The authorized users and particular access rights for authorized users may vary between different domains managed for a single associated entity within server system 100, and the conditions for access may not be the same for all users authorized for a single local surveillance domain. The authorized users defined by an associated controlling entity for a domain may include persons affiliated with the entity and/or persons that are not affiliated with the entity (for example, access under one or more pre-specified conditions may be given to public authority emergency responders, neighbors, customers, the general public, and the like).

In this regard, a domain controlling entity database can be included within management data store 152 for maintaining information records for each entity that is associated with at least one local surveillance domain deployed within environment 10. For each entity for which a record is maintained within the domain controlling entity database, various items of information relevant to the entity, such as name, location, contact information, an identification of each local surveillance domain with which the entity is associated, a user name, password, and other account information for each of one or more administrator user accounts that can be used to log into server system 100 and act on behalf of the entity for management of the local surveillance domains with which the domain controlling entity is associated, and, for each administrator user account (or the administrator user accounts collectively), a specification of the access rights and conditions for access to surveillance data and configuration management operations for each local surveillance domain with which the entity is associated can be included in the respective information record for the entity that is maintained within the domain controlling entity database. If the surveillance data and management services offered by server system 100 are provided for a fee, domain controlling entity database may further contain billing and payment information, although such information may also be maintained separately.

A local surveillance domain database can be included within management data store 152 for maintaining information records for each local surveillance domain deployed within environment 10. For each domain for which a record is maintained within the local surveillance domain database, various items of information relevant to the domain, such as a surveillance domain identifier, an identifier of the domain controlling entity with which the domain is associated, an identifier of a local surveillance domain group that the domain is included within if the domain is part of a group of local surveillance domains that are managed collectively by a single domain controlling entity, a location of the domain and/or other general descriptive information (such as a natural language description), fields for defining various configuration parameters of the surveillance domain, a quantity and identifications of the video sources deployed within the domain, a network address of the router deployed within the domain to supply streaming video data to server system 100, the network address of each other component or device deployed within the domain that is configured to communicate with server system 100 (for example, a network address of any IP camera video source deployed within the domain that is configured to capture and transmit still images to image processing server 120), specific data format and transmission protocols that are utilized by the devices within the domain that transmit surveillance data to server system 100, and any other data as may be useful to describe the domain or its characteristics can be included in the respective information record for the domain that is maintained within the local surveillance domain database.

A video source database can be included within management data store 152 for maintaining information records for each video source of each local surveillance domain deployed within environment 10. For each video source for which a record is maintained within the video source database, various items of information relevant to the video sources, such as a video source identifier, an identification of the local surveillance domain within which the video source is deployed, an identification of any video source group within the local surveillance domain within which the video source is included (which may be used to allow multiple video sources to be designated by a single authorization), a location of the video source and/or other general descriptive information (such as a natural language description), a quantity and identifications of video streams supplied by the video source, a specification of whether the video source is configured to supply still images to server system 100, a network address of the video source, fields for defining various configuration parameters of the video source (for example, orientation, zoom, and directional controls, and image size, compression format used, video quality, and the like for surveillance data captured by the video source), specific data format and transmission protocols that are utilized by the video source, and any other data as may be useful to describe the video source or its characteristics can be included in the respective information record for the video source that is maintained within the video source database.

A user account database can be included within management data store 152 for maintaining account information records for each user that has been granted access rights by a domain controlling entity with respect to at least one local surveillance domain deployed within environment 10 with which the granting entity is associated. For each user for which an account record is maintained within the user account database, various items of information relevant to the user, such as name, contact information, an identification of domain controlling entity that has granted access rights to the user, a user name and password for the user account that can be used to log into server system 100 and access surveillance data and configuration management operations for each local surveillance domain for which the user has been granted access rights, and a specification of the access rights and conditions for access to surveillance data and configuration management operations for each local surveillance domain for which the user has been granted access rights (which may comprise a reference to one or more user groups to which the user belongs or an information record in an authorizations database) can be included in the respective account information record for the user that is maintained within the user account database.

A user groups database can be included within management data store 152 for maintaining information records for users that have been granted access rights as a group by a domain controlling entity with respect to at least one local surveillance domain deployed within environment 10 with which the granting entity is associated. A particular user may belong to one or more user groups for purposes of accessing surveillance data and configuration management operations for each local surveillance domain for which each user group has been granted access rights. A user group may be defined, for example, by an administrator user for a domain controlling entity or another user that has been granted rights to define and administer a user group by a domain controlling entity. For example, access rights may be granted to a set of employees of a domain controlling entity or a public authority emergency response unit as a group without the entity having to determine the identities and maintain a list of each present member of the group. For each user group for which a record is maintained within the user groups database, various items of information relevant to the user group, such as a group identifier, an identification of domain controlling entity that has granted access rights to the user group, an identification of one or more group administrators (that is, the users having authority to administer the group, such as deleting or adding members to the group, a specification of the access rights and conditions for access to surveillance data and configuration management operations for each local surveillance domain for which the user group has been granted access rights (which may comprise a reference to one or more other user groups or an information record in an authorizations database), and any other data as may be useful to describe the user group can be included in the respective information record for the user group that is maintained within the user groups database.

In exemplary embodiments, the specifications of the access rights and conditions for access to surveillance data and configuration management operations for each local surveillance domain that has been granted for each user and each user group can be separately maintained within corresponding information records included in an authorizations database that is maintained within management data store 152 via database server 150 and referenced by fields included in each user account information record in the user account database and each user group information record included in the user groups database. Each information record in such an authorizations database can correspond to a respective pair of a local surveillance domain and a user (or user group) that has been granted access rights to the domain on behalf of the domain controlling entity associated with the domain and can further include verification information that can be used during a user registration process to verify users as having been authorized by the domain controlling entity. In exemplary embodiments, access rights for users and user groups can be specified at any appropriate level of granularity (for example, with respect to particular types of surveillance and management data, particular video sources or video source groups, particular time periods or events, etc.) and according to any appropriate set of hierarchical rules to thereby arbitrate access by multiple parties to multiple sources and types of surveillance data captured and supplied from multiple local surveillance domains.

Referring again to the exemplary embodiment illustrated in FIG. 2, each virtual application server 134 executing within server pool 130 includes video streaming and processing server 140 that is in communication with gateway proxy server 136. As discussed above, a respective receiver module 137 is executing within gateway proxy server 136 to receive each video stream transmitted to server system 100 from each local surveillance domain within environment 10 that is connected to the corresponding virtual application server for each connected video source within the local surveillance domain, and the receiver modules operate to relay each received video stream to video streaming and processing server 140 for further processing. In particular, in the present exemplary embodiment, recording engine 142 of video streaming and processing server 140 is configured to, for each video stream received from gateway processing server 136, perform a video process to convert the streaming video data into a format that is suitable for recording and accessing for playback of the recorded video stream.

In exemplary embodiments, recording engine 142 can be configured to implement, for each received video stream, an adaptive bitrate streaming technique as the video process to encode the source streaming video content at multiple bit rates and then segment each of the different bit rate streams into small multi-second parts for storage in media data store 162 (as will be described in greater detail below). In one example, the video process implemented by recording engine 142 can utilize the HTTP Live Streaming (HLS) protocol to break the overall stream into a sequence of small HTTP-based files (video chunks) of varying bit rates and set duration using a file segmenter, which also produces a set of index files in the m3u8 format that each operate as a playlist file for the video chunks at a given bitrate level as associated metadata. To facilitate efficient management of the streaming video data within media data store 162, recording engine 142 can also be further configured to generate additional associated metadata for each individual video file such as an identifier of the video source that captured the video source and/or the video stream from which the file is generated, an identifier of the local surveillance domain from which the video stream is supplied, a start time of the video included within the file, and a length of the recording in seconds.

In conjunction with executing the video process for each received video stream respectively, recording engine 142 also operates to store each individual video segment along with the associated metadata object for each segment in temporary data store 143 and notify media management component 138 whenever a new video segment is added to the temporary data store. In this regard, media management component 138 is configured to collect the data for each video stream from temporary data store 143 (for example, in predetermined amounts) and access media server 160 to store the data for the video stream (the individual video files along with an auxiliary data structure that contains the associated metadata) in media data store 162.

In the present exemplary embodiment, similar to management data store 152 and database server 150, media data store 162 can comprise a plurality of database tables within a streaming video database that is maintained by media server 160 and commonly accessed by virtual application servers 134 invoked within server pool 130 via database services provided at a front end by media server 160. More specifically, the streaming video database within media data store 162 can comprise a corresponding database table for maintaining the data for each video stream received by virtual application servers 134 executing within server pool 134. In exemplary embodiments, media server 160 can be configured to provide the streaming video database as a structured relational database such as a MySQL database. In this manner, media server 160 can provide for efficient centralized management and search functions of all streaming video data recorded within environment 10. Furthermore, because each individual video file is tagged and recorded in conjunction with associated metadata such as an identifier of the video source that captured the video source and/or the video stream from which the file is generated, a start time of the video included within the file, and a length of the recording in seconds, despite gaps that may occur in the streaming video data for any video stream being supplied from a local surveillance domain (for example, due to a connection loss followed by a reconnection), the data for the non-contiguous video stream can nevertheless be contiguously maintained within and accessed from the same database table of media data store 162 regardless of any change that may occur in the particular receiver module or virtual application server that receives the video stream.

With further reference to FIGS. 1 and 3, in exemplary embodiments and as discussed above, one or more of video sources 210 within local surveillance domains 200 may be configured to capture a sequential series of still images at specific intervals of time for transmission from the local surveillance domain to image processing server 120 via a connection over network 400. In this regard, image processing server 120 can be configured to, for each series of still images captured by a video source and received from a local surveillance domain within environment 10, regularly perform a set of batch processing operations on the received digital image files to generate a set of multiple-image time-lapse files for displaying a video sequence of the still images along with associated thumbnail files that contains information for displaying a thumbnail image for each time-lapse file. More particularly, image processing server 120 can be configured to store the received still images for each video source locally in batches of a predetermined number of contiguous images from the video source, generate a time-lapse file (for example, in the MPEG (Moving Picture Experts Group) or audiovisual (AVI) file format) for each collected batch of contiguous images along with an associated thumbnail file, and access media server 160 to store each time-lapse file along with associated data in media data store 162. The associated data for each time-lapse file can comprise an auxiliary data structure that include the associated thumbnail image along with additional associated metadata for the sequence of still images assembled into the time-lapse file such as an identifier of the video source that captured the image sequence, an identifier of the local surveillance domain from which the still images are supplied, a time at which the first image in the sequence was captured, and a frame rate at which the video source captured the sequence of images. In exemplary embodiments, image processing server 120 can be configured to perform the batch processing operations on each collected batch of received still image files for each series of still images received from a local surveillance domain at specific intervals of time, such as once every day as a preset time. For this purpose, media data store 162 can comprise a plurality of database tables within a time-lapse database that is maintained by media server 160 and commonly accessed by image processing server 120 via database services provided at a front end by media server 160. More specifically, the time-lapse database within media data store 162 can comprise a corresponding database table for maintaining the data (the time-lapse files and associated auxiliary data) for each series of still images captured by a video source and received by image processing server 120 from a local surveillance domain within environment 10. In exemplary embodiments, media server 160 can be configured to provide the time-lapse database as a structured relational database such as a MySQL database. In this manner, media server 160 can provide for efficient centralized management and search functions of all time-lapse files recorded based on still images captured within environment 10. Furthermore, because each individual time-lapse file is recorded in conjunction with a thumbnail image and associated metadata such as an identifier of the video source that captured the image sequence and a time at which the first image in the sequence was captured, despite gaps that may occur between still images supplied from a particular video source beyond the predetermined intervals (for example, due to a connection loss followed by a reconnection), the time-lapse files assembled for the video source can nevertheless be contiguously maintained within and accessed from the same database table of media data store 162.

Referring again to FIG. 1, client systems 300 are user terminals or other computing devices to which one or more users, which may be persons having authorization from the associated entity for a local surveillance domain or their human agents (for example, personal representatives or assistants), have access. It should be noted that the term “user” is used herein to refer to one who uses a computer system, such as one of client systems 300. As described in greater detail below, client systems 300 are each operable by such users to access server system 100 via network 400 and act as clients to access services provided by the server system 100 within exemplary environment 10. For this purpose, each client system implements software for executing a respective client application 310 on the client system that allows a user to interact with server system 100 to access services provided via virtual application servers 134 executing within server pool 130. Such client applications may also be referred to as client modules, or simply clients, and may be implemented in a variety of ways. In exemplary embodiments, such client applications can be implemented as any of a myriad of suitable client application types, which range from proprietary client applications (thick clients) to web-based interfaces in which the user agent function is provided by a web server and/or a back-end program (for example, a CGI program).

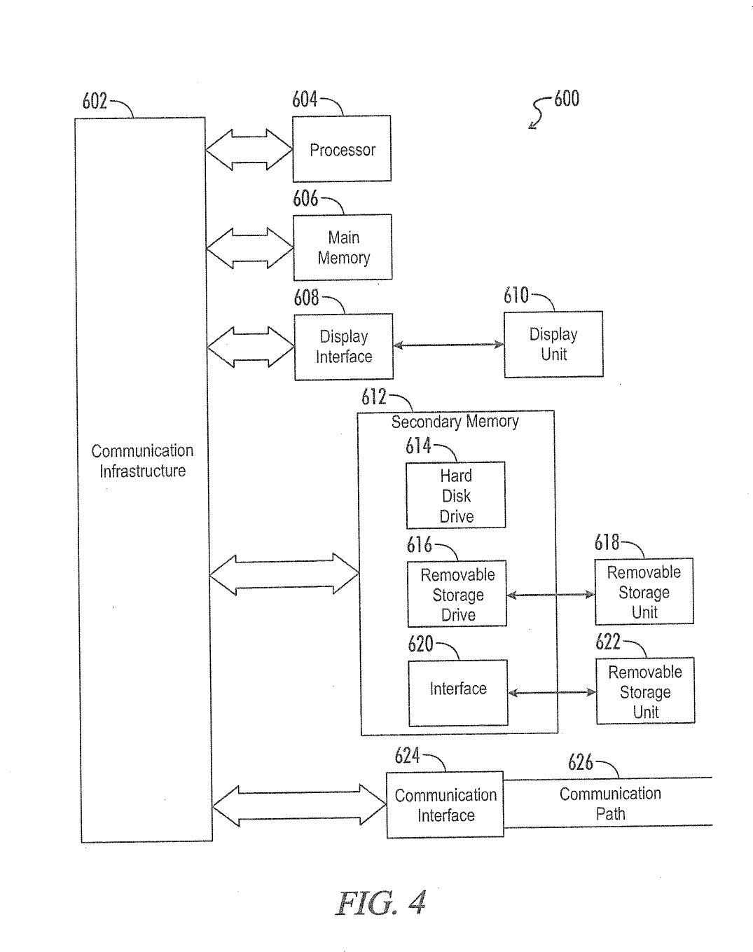

In exemplary embodiments, the computer systems of client systems 300 can be any of a wide range of suitable computing devices such as one or more workstations, desktop computers, laptops, or other personal computers (PCs) (for example, IBM or compatible PC workstations running the MICROSOFT WINDOWS operating system or LINUX OS, MACINTOSH computers running the MAC OSX operating system, or equivalent), non-traditional-computer digital devices such as Personal Digital Assistants (PDAs) and other handheld or portable electronic devices, smart phones and other mobile handsets, tablet computers, netbook computers, game consoles, home theater PCs, desktop replacement computers, and the like, or any other suitable information processing devices. An exemplary computer system for client systems 300 is described in greater detail below with reference to FIG. 4.

In general, during operation of exemplary server system 100, a client system 300 first establishes a connection to server system 100 via network 400. In particular, initial requests for connection to server system 100 from client systems 300 are directed to load balancer 116 of management server 110. For example, load balancer 116 can be implemented to perform listening on the port of server system 100 to which client systems 300 connect to access services to thereby serve as the initial client access point for server system 100. In response to connection requests received from client systems to access services at server system 100, load balancer 116 can be configured to distribute client sessions over the set of active virtual application servers 134 that are executing within server pool 130 as the connection requests are received according to a scheduling algorithm so that client workload is shared and spread across the active virtual application servers 134. More specifically, load balancer 116 can respond to each connection request from a client system with a destination IP address and port of the virtual application server to which the client session with server system 100 is assigned according to the scheduling algorithm implemented by the load balancer. Client applications 310 can be configured to then use this connection information received from load balancer 116 to connect to and establish a client session with the virtual application server to which the client system is assigned to thereby access services provided by server system 100, as described in greater detail below.

To distribute client workload, load balancer 116 can be configured to implement any suitable scheduling algorithm, such as random choice or round robin algorithms, for purposes such as maximizing throughput, minimizing response time, and/or avoiding overload of any single virtual application server. In exemplary embodiments, load balancer 116 can be configured to access information monitored and maintained by optimization engine 114 to implement a more-sophisticated suitable scheduling algorithm that takes additional factors into account, such as the load, least response times, number of active connections, or how many client connections have recently been assigned for each virtual application server. In exemplary embodiments, optimization engine 114 can be further configured to monitor each client session with an assigned virtual application server and maintain session information for each client session. Optimization engine 114 can utilize this information when provisioning virtual application servers 134 within server pool 130 for execution. In addition, by allowing management server 110 to be session-aware, this information may also be utilized by optimization server 114 to migrate client sessions to other virtual application servers (for example, during a consolidation operation) and to automatically reconnect a client system to a disconnected session even where load balancer 116 assigns the client system to a different virtual application server in response to the reconnection attempt.

Once a session has been established between a client system and the assigned virtual application server within server pool 130 that is assigned to the client system by load balancer 116, the connected client system may directly or indirectly transmit data to and access content from the assigned virtual application server. A user accessing server system 100 through the connected client system can thereby use the client application executing on the client system to access services provided by the assigned virtual application server, which are described in greater detail below, via a user interface implemented by the client application within which the client application renders the information served by the virtual application server.

In exemplary embodiments, virtual application servers 134 can be implemented to provide services to client systems 300 as a non-web application (such as a mobile application), a web application, or both, and client applications 310 can correspondingly be implemented as non-web client applications, web client applications, or both for operation by users of the client systems to interact with assigned virtual application servers and access the services provided thereby. For example, each virtual application server can comprise a common web server configured to provide a web application for respective client applications implemented on client systems 300 that are implemented to provide web-based user interfaces for utilizing the services provided by the web server. The user interfaces of client applications 310 implemented on client systems 300 can be configured to provide various options corresponding to the functionality offered in exemplary embodiments described herein through suitable user interface controls (for example, by way of menu selection, point-and-click, dialog box, or keyboard command). In one general example, the user interfaces may provide “send” or “submit” buttons that allow users of client applications 310 to transmit requested information to the assigned virtual application servers. The user interfaces can be implemented, for example, as a graphical user interface (GUI) that renders a common display structure to represent the services provided by virtual application servers 134 for users of client systems 300.

More specifically, virtual application servers 134 can, for example, be configured to provide services by implementing a common web-based software application hosting a corresponding website that includes a number of web pages (for example, display screens), and client applications 310 can comprise a web browser executing on client systems 300, such that the services provided by assigned virtual application servers 134 are accessible to client systems 300 using the Internet or an intranet. Each user of a client system may thereby access the website commonly hosted by virtual application servers 134 by, for example, inputting or following a link to the uniform resource locator (URL) for the website in the web browser, which load balancer 116 receives and handles as an initial connection request by directing the web browser to the particular version of the website that is hosted by the virtual application server assigned to the client system, to enable the user to display and interact with information, media, and other content embedded within the web pages of the website provided by the virtual application server. The web-based software application can transmit information that can be processed by the web browsers to render a user interface using, for example, browser-supported programming languages such as JavaScript, HTML, HTML5, and CSS, or the like, and can communicate with the web browsers using, for example, HTTPS, POST and/or GET requests. Client applications 310 and server system 100 may be configured so that information transmitted between client systems 300 and server system 100 can be encrypted and sent over a secure network connection, and server system 100 may be located behind a firewall with respect to the client systems.

In the present exemplary embodiment, virtual application servers 300 can be implemented to provide a respective set of services for each of various types of users (for example, unregistered guests, administrator users with authorization to act on behalf of the domain controlling entity associated with one or more local surveillance domains to perform management of the local surveillance domains, authorized users that have been granted particular access rights by a domain controlling entity for one or more local surveillance domains with which the entity is associated, and the like), and some of the services offered by the virtual application servers can be commonly applicable to and accessible by all types of users, while other services can be applicable to and accessible only by specific types of users or by users that have been granted specific access rights. For example, administrator users authorized by a domain controlling entity will typically be provided with greater access rights within server system 100 with respect to the local surveillance domains with which the entity is associated and, therefore, will typically be able to access a greater range of services provided by virtual application servers 134 with respect to the local surveillance domains. As another example, authorized users and particular access rights for authorized users, and thus the services that are accessible to authorized users, may vary between different local surveillance domains managed for a single associated entity within server system 100. In exemplary embodiments, the particular client applications 310 or the particular client systems 300 that are utilized for accessing server system 100 can be respective to and customized for each type of user account. For example, the particular client application that is utilized for particular types of users can be implemented to a provide virtual computing platform that is specific to the services offered for that type of user.

In this regard, as noted above with reference to FIG. 2, each virtual application server includes administration services component 144 and user services component 146. Administration services component 144 is implemented to provide a set of administrative services to users accessing server system 100 via any of client systems 300, and user services component 146 is implemented to provide a set of services for accessing surveillance data captured within environment 10 to authorized users accessing server system 100 via any of client systems 300. As discussed above, virtual application servers 134 can implement a user interface so that users of connected client systems 300 can access various services provided by the application server with relative ease by operating a corresponding client application 310, and, in exemplary embodiments, the user interface can be a web-based user interface, implemented as a web-based software application hosting a corresponding website that provides a number of web pages (that is, screens) to offer the services implemented by application server 116 to users. For example, a user can access the corresponding website using a web browser implemented within a client application 310 executing on a client system 300.

In exemplary embodiments, when any user, regardless of whether the user is registered with system 100 with any type of user account or a non-registered user, operates a client system 300 to access server system 100 (for example, by launching a native client application or by using a web browser to submit a URL that provides a network address for server system 100, which load balancer 116 handles as an initial connection request by directing the web browser to the particular version of the website that is hosted by an virtual application server executing within server pool 130 that is assigned to the client system), the assigned virtual application server can be configured with a default setting that directs the user to a home page, at which the user is presented with various options accessible through interface elements within the user interface implemented by the virtual application server to access registration and login functions provided by administration services component 144.

The user interface element within such a home page providing an option to register with server system 100 may be, for example, provided as a “Register an account” button rendered at the client application, and administration services component 144 may be configured to, in response a user accessing the user interface element, provide further user interface controls for allowing the user to specify a type of user account that the user intends to register with server system 100.

For example, upon the user indicating an intention to register as an administrator user on behalf of a domain controlling entity, the user will be able to initiate a registration session with administration services component 144 to register an administrator account with server system 110. For this purpose, administration services component 144 may be configured to implement a series of pages with user interface controls that are accessible by the user to guide the user through the account registration process and prompt the user to input various types of administrator user account information to be maintained by database server 150 within a respective information record in the domain controlling entity database for the domain controlling entity on behalf of which the user has been authorized to perform management for one or more local surveillance domains with which the entity is associated. The administrator account information may include, for example, name, address or location information, contact information, and any other suitable identifying or descriptive information. Administration services component 144 may also be configured to, during this process, access the authorizations database to verify that the particular user has, in fact, been authorized to act on behalf of the corresponding domain controlling entity for the information record during this registration process prior to establishing the administrator account information for the user within the information record, and the information used to perform this verification may be included within the initial set of information that is established for the entity within management data store 152. For each authorized administrator user, this initial set of information may further include the specification of the access rights and configuration management operations granted to the particular user for each local surveillance domain with which the entity is associated. The administrator account information for a verified user that is established within the information record for the entity within the domain controlling entity database can further include a unique user name and be protected by a password, which can be used by the user to log into the administrator account when accessing server system 100 over network 400. Additional security mechanisms could also be implemented by administration services component 144 during the registration process for access to and/or protection of information, such as challenge questions, encryption keys for encrypting sensitive data, etc.

Likewise, upon the user indicating an intention to register as authorized user that has been granted certain access rights to one or more local surveillance domains by an associated domain controlling entity, the user will be able to initiate a registration session with administration services component 144 to register an user account with server system 110. For this purpose, administration services component 144 may be configured to implement a series of pages with user interface controls that are accessible by the user to guide the user through the account registration process and prompt the user to input various types of user account information such as, for example, name, address or location information, contact information, and any other suitable identifying or descriptive information, and to access database server 150 to create a respective account information record for the user to be maintained within the user account database based on this information input by the user during the registration process. Administration services component 144 may also be configured to, during this process, access the authorizations database to verify that the particular user has, in fact, been granted access rights to one or more local surveillance domains by a specified domain controlling entity during this registration process prior to establishing the account information record for the user within the user account database, and the information used to perform this verification may be included within the initial set of information that is established for the entity within management data store 152. For each authorized user, this initial set of information may further include the specification of the access rights granted to the particular user for each local surveillance domain with which the entity is associated. The account information record for a verified user that is established within the user account database can further include a unique user name and be protected by a password, which can be used by the user to log into the user account when accessing server system 100 over network 400. Additional security mechanisms could also be implemented by administration services component 144 during the registration process for access to and/or protection of information, such as challenge questions, encryption keys for encrypting sensitive data, etc.

Upon a user registering an administrator or authorized user account with server system 100 to establish an account information record and operating a client application executing on a client system to log into his or her customer account (for example, by accessing a login user interface element or a login screen within the user interface implemented by administration services component 144 to provide the user name and password associated with the account), the user can then be presented with various options accessible through interface elements within the user interface implemented by the virtual application server to access various management functions provided by administration services component 144 and various functions provided by user services component 146 for viewing captured surveillance data for which the user has been granted access rights by a domain controlling entity.

In particular, administration services component 144 can be configured to implement user interface controls within one or more interactive screens that are accessible by the user to perform management functions such as editing of profile data and authorization information, defining and administering user groups for the domain controlling entity by which the user has been granted access rights, performing management of recorded surveillance data within media data store 162 for the domain controlling entity by which the user has been granted access rights, and viewing configuration settings and performing configuration management operations for each local surveillance domain for which the user has been granted access rights in accordance with the particular access rights granted to the user. Such configuration management operations for a local surveillance domain may include, for example, setting operational characteristics such as video source settings (including capture and positional characteristics, whether to capture still pictures and/or streaming video data), record characteristics (such as recording schedules, resolution, precord, frame rate, and the like), and system rules (for example, the manner by which components of the local surveillance domain respond to triggered events). In exemplary embodiments, administration services component 144 can be configured to, in response to a user operating a client application to input operational characteristics for a local surveillance domain, establish a connection with the router for the local surveillance domain over network 400 and transmit instructions to the local controller via the connection with the router to apply the operational characteristics input by the user to the relevant components of the local surveillance domain. For this purpose, local controller 230 of each local surveillance domain 200 can include a configuration module configured to process such instructions received from server system 100 and direct implementation of operational characteristics within the local surveillance domain to thereby configure the relevant components in accordance with the instructions.

Likewise, user services component 146 can be configured to implement user interface controls within one or more interactive screens that are accessible by the user for viewing captured surveillance data from local surveillance domains to which the user has been granted access rights by a domain controlling entity. In particular, user services component 146 can be configured to implement various user interface controls within the client application for allowing the user to view and analyze live video streams, recorded streaming video data stored within media data store 162, and time-lapse files stored within the media data store for each video source for which the user has been granted access rights to perform remote monitoring at the client system. For example, a graphical user interface (GUI) may be implemented within a client application by a virtual application server to which the client system has been assigned in accordance with exemplary embodiments of the present invention to provide services for viewing and monitoring of captured surveillance data.

More particularly, such a GUI may include, for example, a “Videos” tab that can be selected by the user to access live video streams and recorded streaming video data within the GUI. Upon the user selecting the “Videos” tab, user services component 146 can navigate the user to a video viewing screen that includes an embedded video playback user interface element for each video source to which the user been granted access rights. In exemplary embodiments, user services component 146 can be configured to provide the video playback user interface elements for the video sources to which the user been granted access rights within a plurality of such video viewing screens in which each of the video viewing screens includes a subset of these video sources (for example, each video viewing screen can be provided for the video sources within a respective local surveillance domain to which the user has access rights or for the video sources within a respective camera group to which the user has access rights). In exemplary embodiments, user services component 146 can be configured to allow for the user to access and playback live video streams and/or recorded streaming video data from multiple video sources simultaneously within multiple embedded video playback elements within a single video viewing screen and to allow the user the select one of embedded video playback elements to render a larger version of the embedded video playback element by itself within the full video viewing screen. In such embodiments, user services component 146 may be further configured to implement user interface controls within the video viewing screen that are accessible by the user to toggle between the multiple embedded video playback elements and each embedded video playback elements individually within the video viewing screen.

In exemplary embodiments, the video playback element for each video source implemented by user services component 146 can provide a set of user interface controls for alternately accessing both a live video stream and recorded streaming video data from the particular video source. In response to the user selecting the user interface control within the video playback element for a particular video source to access the live video stream, the video playback element can be configured to direct the client application to establish a connection over network 400 with the video streaming and processing server 140 of the particular virtual application server executing within server pool 130 to which the local surveillance domain that includes the video source selected by the user has been allocated and, upon this connection being established, transmit a request to that video streaming and processing server 140 to receive the live streaming video data for the selected video source. This request can be handled at the particular video streaming and processing server 140 by streaming engine 141. In particular, streaming engine 141 can be configured to continuously generate and relay a copy of the video stream as it is being received from the selected video source in a form supported by the video playback element of the user interface implemented by user services component 146 over network 400 to the client system operated by the user for rendering of the live streaming video data within the corresponding video playback element. For this purpose, the video playback element may include a “stop” button that enables the user to terminate the continuous live streaming retrieval process and a “play” or “refresh” button that enables the user to reinitiate continuous live streaming retrieval process. In exemplary embodiments, user services component 146 can be configured to implement user interface controls within the video viewing screen when multiple embedded video playback elements are provided within the video viewing screen simultaneously that are accessible by the user to enable such “stop” and “play” or “refresh” functionality for the live streaming retrieval process for video data from the multiple corresponding video sources concurrently.

In exemplary embodiments, streaming engine 141 or user services component 146 can be further configured to terminate the continuous live streaming retrieval process and stop playback of the live video stream within one or more video playback elements included in the video viewing screen at any given time upon expiration of a predetermined time period occurring without any interaction from the user. In exemplary embodiments, for each video stream being received by video streaming and processing server 140, streaming engine 141 can be configured to relay the video stream concurrently with the processing of the video stream by recording engine 142, and the streaming engine can be configured to relay multiple copies of the video stream simultaneously in response to receiving requests from multiple client systems.

In exemplary embodiments, the video playback element for each video source implemented by user services component 146 can further include user interface controls for allowing the user to perform real-time control of the video source while accessing the live video stream for the video source via the video playback element. For example, the video playback element can include real-time controls that are accessible by the user to alter the pan-tilt-zoom (PTZ) position and control an intensity and on/off state of a light source of the video source capturing the live video stream. In response to the user accessing such real-time control elements to direct control of the video source, user services component 146 can be configured to establish a connection with the router for the local surveillance domain in which the particular video source is included over network 400 and transmit instructions to the local controller via the connection with the router to apply the real-time control operations requested by the user to the particular video source.

To enable the user to access recorded streaming video data for a particular video source, the video playback element for the particular video source implemented by user services component 146 can include user interface controls allowing the user to select a particular period of time of interest or a starting date and time of interest. For example, the video playback element can include an input field and/or a calendar-type user interface control that allows the user to select a particular date and time or a particular time period, and, after the date and time or the time period has been selected, the user can select a “Go” button. User services component 146 can be configured to, in response to such a selection by the user, generate a database query for directing media server 160 to retrieve the recorded streaming video data captured by the particular video source for the time period or starting at the date and time specified by the user from media data store 162. Any suitable database search techniques may be utilized to delineate the parameters of the query. User services component 146 can then transmit this query in a request to media management component 138 of the virtual application server within which the user services component is executing.

Media management component 138 can be configured to, in response to receiving the request, submit the query to access media server 160 to retrieve the streaming video data files corresponding to the request and, upon receiving the corresponding streaming video data, perform processing on the received video data files to convert the files into a standard playback format supported by and suitable for distribution to the video playback element of the user interface implemented by user services component 146 such as, for example, mp4 or Ogg, and then return the converted video data files corresponding to the request to user services component 146 for transmission to the client system over network 400. Client application 310 can be configured to cache the retrieved video data files received from user services component 146 at client system 300 to enable the user to control viewing of the retrieved streaming video data via user interface controls implemented within the video playback element for the corresponding video source. Such user interface controls may be accessible by the user to, for example, direct client application 310 to start, stop, and adjust the speed of playback of the retrieved streaming video data within the video playback element. As another example, such user interface controls may be accessible by the user to direct client application 310 to playback a most recent segment of the retrieved video data of a predetermined length (for example, three minutes in length) that ends at a current date and time, and to specify a particular date and time and direct client application 310 to playback of a corresponding segment of the retrieved video data of a predetermined length that starts from or ends at the specified date and time.

In exemplary embodiments, such user interface controls may be accessible by the user to direct client application 310 to display a plurality of thumbnail images within the video playback element taken at periodic intervals within the retrieved video data files, where each thumbnail image is selectable by the user to direct playback of a corresponding segment of the retrieved video data of a predetermined length starting from the point at which the thumbnail was taken within the video playback element.

In exemplary embodiments of the present invention, the GUI that may be implemented within a client application by a virtual application server to which the client system has been assigned to provide services for viewing and monitoring of captured surveillance data may also include an “Images” tab that can be selected by the user to access time-lapse file data generated and stored within media data store 162 for any video source for which the user has been granted access rights. More particularly, user services component 146 can be configured to, upon the user selecting the “Images” tab navigate to the user to an image viewing screen that includes an user interface element for each video source to which the user been granted access rights (or a subset of these video sources) having a selectable still image for the video source, and, upon the user accessing such a user interface element to select the still image for a particular video sources, an embedded image playback user interface element can be provided within the image viewing screen with respect to the selected video source. Upon being opened within the user interface implemented at the client application, the image playback element can be configured to direct the client application to establish a connection over network 400 with media server 160 and transmit a request to the media server for time-lapse file data stored for the video source over a particular time period.

In exemplary embodiments, user services component 146 can be configured to implement user interface controls that allow the user to time period or start date and time, or the image playback element can specify a default time period or start date and time, for the client application to include in the request when the image playback element is initially rendered. The request can be generated and transmitted by client application 310 in the form of database query for directing media server 160 to retrieve the corresponding time-lapse file data captured by the particular video source for the specified start date and time or time period from media data store 162 (which may include, for example, the corresponding time-lapse file data captured by the particular video source for the specified start date and time to a current date and time). The image playback element can include user interface controls allowing the user to specify a particular start date and time or period of time of interest for client application 300 to include in an updated request to media server 160 for time-lapse file data captured by the particular video source.

Upon receiving the corresponding time-lapse file data retrieved returned by media server 160 over network 400 in reply to such a request, client application 310 can be configured to cache the received time-lapse file data at client system 300 to enable the user to control viewing of the retrieved time-lapse files via user interface controls implemented within the image viewing screen. For example, image viewing screen can be configured to render a main image playback element for the retrieved time-lapse file that begins at a specified date and time and includes a display of the associated thumbnail image for the time lapse file in a main portion of the image viewing screen, as well as to render a respective user interface element for each other retrieved time-lapse file that includes a display of the associated thumbnail image for the time-lapse file within a secondary portion of the image viewing screen (for example, in a sidebar portion of the image viewing screen) and, upon a particular associated thumbnail image within the secondary portion of the image viewing screen being selected by the user, render a main image playback element for the retrieved time-lapse file for the selected associated thumbnail image in a main portion of the image viewing screen and replace the respective user interface element for the time-lapse file for the selected associated thumbnail image within the secondary portion of the image viewing screen with a respective user interface element for the retrieved time-lapse file that begins at the specified date and time.

In exemplary embodiments, user services component 146 can be configured to, for the main image playback element rendered for a retrieved time-lapse file that is presently rendered in the main portion of the image viewing screen, provide a set of user interface controls that are accessible by the user to interact with the thumbnail image (such as by adjusting a zoom level at which the image is rendered, highlighting a selected portion or area of the image to be magnified within the main portion of the image viewing screen or display a magnified version thereof in conjunction with the rendered image within the main portion of the image viewing screen, and the like), compare the thumbnail image with another thumbnail image included in the retrieved time-lapse file data (for example, by specifying particular dates and times to compare by displaying the images corresponding to each of the specified dates and times simultaneously within the main portion of the image viewing screen), and initiate playback of the time-lapse file within the main portion of the image viewing screen. The image viewing screen may also include user interface controls accessible by the user to, for example, start and stop playback of the selected time-lapse file, as well as to initiate playback of a preceding, subsequent, or other time-lapse file of the retrieved time-lapse file data, within the image viewing screen.

Aspects of exemplary embodiments of the present invention described herein can be implemented using one or more program modules and data storage units. As used herein, the term “modules”, “program modules”, “components”, “systems”, “tools”, “utilities”, and the like include routines, programs, objects, components, data structures, and instructions, or instructions sets, and so forth that perform particular tasks or implement particular abstract data types. As can be appreciated, the modules refer to computer-related entities that can be implemented as software, hardware, firmware and/or other suitable components that provide the described functionality, and which may be loaded into memory of a machine embodying an exemplary embodiment of the present invention. Aspects of the modules may be written in a variety of programming languages, such as C, C++, Java, etc. The functionality provided by modules used for aspects of exemplary embodiments described herein can be combined and/or further partitioned.

As used herein, the terms “data storage unit,” “data store”, “storage unit”, and the like can refer to any suitable memory device that may be used for storing data, including manual files, machine readable files, and databases. The modules and/or storage units can all be implemented and run on the same computing system (for example, the exemplary computer system illustrated in FIG. 4 and described below) or they can be implemented and run on different computing systems. For example, one or more modules can be implemented on a personal computer operated by a user while other modules can be implemented on a remote server and accessed via a network.

In exemplary embodiments, the client applications utilized in exemplary embodiments of the present invention can be configured for incorporation within any suitable network computing environment as a plug-in, add-on, or extension. As used herein, the term “plug-in” can refer to a software application or module program, or one or more computer instructions, which may or may not be in communication with other software applications or modules, that interacts with a host application to provide specified functionality, and which may include any file, image, graphic, icon, audio, video, or any other attachment. In other exemplary embodiments, the client applications can be implemented as a standalone program that is run as a separate computer process, a portable application, a part of a software bundle, or any other suitable implementation.

In the preceding description, for purposes of explanation, numerous specific details are set forth in order to provide a thorough understanding of the described exemplary embodiments. Nevertheless, one skilled in the art will appreciate that many other embodiments may be practiced without these specific details and structural, logical, and electrical changes may be made.

Some portions of the exemplary embodiments described above are presented in terms of algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Exemplary embodiments of the present invention can be realized in hardware, software, or a combination of hardware and software. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: (a) conversion to another language, code or, notation; and (b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 4 is a block diagram of an exemplary computer system 600 that can be used for implementing exemplary embodiments of the present invention. Computer system 600 includes one or more processors, such as processor 604. Processor 604 is connected to a communication infrastructure 602 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary computer system 600 can include a display interface 608 that forwards graphics, text, and other data from the communication infrastructure 602 (or from a frame buffer not shown) for display on a display unit 610. Computer system 600 also includes a main memory 606, which can be random access memory (RAM), and may also include a secondary memory 612. Secondary memory 612 may include, for example, a hard disk drive 614 and/or a removable storage drive 616, representing a floppy disk drive, a magnetic tape drive, an optical disk drive, etc. Removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, removable storage unit 618 includes a computer usable storage medium having stored therein computer software and/or data.

In exemplary embodiments, secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (that is, channel) 626. Channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface including a wired network or a wireless network that allow a computer to read such computer readable information.

Computer programs (also called computer control logic) are stored in main memory 606 and/or secondary memory 612. Computer programs may also be received via communications interface 624. Such computer programs, when executed, can enable the computer system to perform the features of exemplary embodiments of the present invention as discussed herein. In particular, the computer programs, when executed, enable processor 604 to perform the features of computer system 600. Accordingly, such computer programs represent controllers of the computer system.

While the invention has been described in detail with reference to exemplary embodiments, it will be understood by those skilled in the art that various changes and alternations may be made and equivalents may be substituted for elements thereof without departing from the scope of the invention as defined by the appended claims. In addition, many modifications may be made to adapt a particular application or material to the teachings of the invention without departing from the essential scope thereof.

Variations described for exemplary embodiments of the present invention can be realized in any combination desirable for each particular application. Thus particular limitations, and/or embodiment enhancements described herein, which may have particular limitations need be implemented in methods, systems, and/or apparatuses including one or more concepts describe with relation to exemplary embodiments of the present invention.

Therefore, it is intended that the invention not be limited to the particular embodiments disclosed as the best mode contemplated for carrying out this invention, but that the invention will include all embodiments falling within the scope of the present application as set forth in the following claims, wherein reference to an element in the singular, such as by use of the article “a” or “an” is not intended to mean “one and only one” unless specifically so stated, but rather “one or more.” Moreover, no claim element is to be construed under the provisions of 35 U.S.C. §112, sixth paragraph, unless the element is expressly recited using the phrase “means for” or “step for.” These following claims should be construed to maintain the proper protection for the present invention.

What is claimed is:

1. A method for recording and distributing surveillance data within a networked video surveillance system, the method comprising:
dynamically allocating one or more virtual application servers executing within a server pool on one or more physical host systems to a plurality of local surveillance domains;
establishing a respective connection between a corresponding network node within each local surveillance domain and the virtual application server allocated to the local surveillance domain over a network; and
receiving one or more live video streams captured by one or more video sources within each local surveillance domain and transmitted from the corresponding network node of the local surveillance domain via the respective connection to the virtual application server allocated to the local surveillance domain.

2. The method of claim 1, wherein each local surveillance domain comprises a local domain controller that is communicatively coupled to the corresponding network node of the local surveillance domain and a plurality of video sources communicatively coupled to the corresponding network node of the local surveillance domain via a local area network for the local surveillance domain, and
wherein the corresponding network node of each local surveillance domain is configured to receive at least one live video stream captured by each of the plurality of video sources of the local surveillance domain and transmitted from the video source to the corresponding network node via the local area network for the local surveillance domain.

3. The method of claim 2, wherein dynamically allocating the one or more virtual application servers executing within the server pool to the plurality of local surveillance domains comprises, for each local surveillance domain:
receiving, from the local domain controller of the local surveillance domain, a first request that includes a notification that the corresponding network node of the local surveillance domain has become operative and an indication of a quantity of the video sources of the local surveillance domain that are presently transmitting at least one live video stream to the corresponding network node of the local surveillance domain;
determining whether any of the virtual application servers executing within the server pool has sufficient availability to be allocated to the local surveillance domain based on the quantity of the video sources of the local surveillance domain specified in the first request;
upon determining that at least one of the virtual application servers executing within the server pool has sufficient availability to be allocated to the local surveillance domain, allocating one of the at least one of the virtual application servers to the local surveillance domain;
upon determining that none of the virtual application servers executing within the server pool has sufficient availability to be allocated to the local surveillance domain, invoking an additional virtual application server within the server pool and allocating the additional virtual application server to the local surveillance domain; and
transmitting an acknowledgement message to the local domain controller of the local surveillance domain that specifies the virtual application server allocated to the local surveillance domain.

4. The method of claim 3, wherein the local domain controller of each local surveillance domain is configured to monitor an operating state of the corresponding network node of the local surveillance domain and, in response to detecting that the corresponding network node of the local surveillance domain has become operative, perform a detection of each live video stream presently being transmitted by the video sources of the local surveillance domain to the corresponding network node and generate the first request based on the detection.

5. The method of claim 3, further comprising monitoring state and performance information for each of the virtual application servers executing within the server pool, dynamically provisioning additional virtual application servers for execution within the server pool based on the state and performance information for the virtual application servers and a present demand for virtual application server resources, and dynamically consolidating allocations of virtual application server resources based on the state and performance information for the virtual application servers and the present demand for virtual application server resources, and wherein, for each first request received from the local domain controller of any of the local surveillance domains, whether any of the virtual application servers executing within the server pool has sufficient availability to be allocated to the local surveillance domain is further determined based on an analysis of the state and performance information for the virtual application servers executing within the server pool.

6. The method of claim 3, wherein establishing the respective connection between the corresponding network node within each local surveillance domain and the virtual application server allocated to the local surveillance domain comprises, for each local surveillance domain:
receiving a second request from the local domain controller of the local surveillance domain to establish a respective logical connection over the network between a gateway proxy server of the virtual application server allocated to the local surveillance domain and the local domain controller of the local surveillance domain for each live video stream presently being transmitted by the video sources of the local surveillance domain to the corresponding network node of the local surveillance domain that includes a unique identifier of each live video stream presently being transmitted by the video sources to the corresponding network node;
invoking, based on the second request, a respective receiver module within the gateway proxy server of the virtual application server allocated to the local surveillance domain for each live video stream presently being transmitted by the video sources of the local surveillance domain to the corresponding network node of the local surveillance domain; and
establishing the respective logical connection for each live video stream presently being transmitted by the video sources of the local surveillance domain to the corresponding network node of the local surveillance domain between the respective receiver module for the live video stream and the corresponding network node of the local surveillance domain.

7. The method of claim 6, wherein the local domain controller of each local surveillance domain is configured to, in response to receiving the acknowledgement message that specifies the virtual application server allocated to the local surveillance domain, configure a virtual private network (VPN) over the network for communication between the corresponding network node of the local surveillance domain and the gateway proxy server of the virtual application server allocated to the local surveillance domain and generate the second request in reply to the acknowledgement message to include an indication of the VPN,
wherein, to establish the respective connection between the corresponding network node within each local surveillance domain and the virtual application server allocated to the local surveillance domain, the respective logical connection for each live video stream presently being transmitted by the video sources of the local surveillance domain to the corresponding network node is established over the VPN configured by the local domain controller of the local surveillance domain in accordance with the indication of the VPN included in the second request received from the local domain controller, and
wherein the corresponding network node of each local surveillance domain is configured to, upon the respective logical connection for each live video stream presently being transmitted by the video sources of the local surveillance domain to the corresponding network node being established, transmit the live video stream over the respective logical connection established for the live video stream in conjunction with the unique identifier of the live video stream to the respective receiver module for the live video stream.

8. The method of claim 6, wherein the gateway proxy server of each virtual application server executing within the server pool is configured to, for each local surveillance domain to which the virtual application server is allocated, monitor the respective logical connection established for each live video stream presently being transmitted by the video sources of the local surveillance domain to the corresponding network node of the local surveillance domain and, upon discovering that the respective logical connection between the respective receiver module for any of the live video streams and the corresponding network node of the local surveillance domain is inactive, attempt to reestablish the respective logical connection for the live video stream and, if unsuccessful in attempting to reestablish the respective logical connection for the live video stream, terminate the respective receiver module for the live video stream and transmit a notification that the respective logical connection is inactive to the local domain controller of the local surveillance domain.

9. The method of claim 6, wherein the gateway proxy server of each virtual application server executing within the server pool is configured to, for each local surveillance domain to which the virtual application server is allocated, monitor the respective connection between the corresponding network node of the local surveillance domain and the virtual application server and, upon discovering that the respective connection is inactive, attempt to reestablish the respective logical connection and, if unsuccessful in attempting to reestablish the respective connection, terminate the respective receiver module invoked within the gateway proxy server for each live video stream transmitted by the video sources of the local surveillance domain to the corresponding network node.

10. The method of claim 6, wherein receiving one or more live video streams captured by one or more video sources within each local surveillance domain comprises, for each local surveillance domain:
receiving, at the respective receiver module for each live video stream presently being transmitted by the video sources of the local surveillance domain to the corresponding network node of the local surveillance domain, the live video stream transmitted from the corresponding network node over the respective logical connection established for the live video stream in conjunction with the unique identifier of the live video stream; and
relaying each live video stream received from the corresponding network node of the local surveillance domain in conjunction with the unique identifier of the live video stream from the respective receiver module for the live video stream to a video streaming and processing server implemented within the virtual application server allocated to the local surveillance domain.

11. The method of claim 10, wherein the local domain controller for each local surveillance domain is configured to:
upon the respective connection between the corresponding network node of the local surveillance domain and the virtual application server allocated to the local surveillance domain being established, monitor the video sources of the local surveillance domain;
upon detecting any video source of the local surveillance domain connecting to the corresponding network node of the local surveillance domain to transmit a live video stream for which a respective logical connection between the gateway proxy server of the virtual application server allocated to the local surveillance domain and the local domain controller is not presently established, transmit a request to a gateway broker for the server pool to establish a respective logical connection over the network between the gateway proxy server of the virtual application server allocated to the local surveillance domain and the local domain controller for the live video stream that includes a unique identifier of the live video stream; and
upon detecting a connection between the corresponding network node of the local surveillance domain and any video source of the local surveillance domain transmitting at least one live video stream to the corresponding network node for which a respective logical connection between the gateway proxy server of the virtual application server allocated to the local surveillance domain and the local domain controller is presently established becoming inactive, transmit a notification to the gateway broker that each live video stream being captured by the video source for which a respective logical connection is presently established is not presently active.

12. The method of claim 11, further comprising:
upon the gateway broker receiving a request from the local domain controller for any local surveillance domain to which a virtual application server executing within the server pool is allocated to establish a respective logical connection over the network between the gateway proxy server of the virtual application server and the local domain controller for a live video stream being transmitted by any video source of the local surveillance domain to the corresponding network node of the local surveillance domain for which a respective logical connection between the gateway proxy server of the virtual application server and the local domain controller is not presently established, invoking, based on the request, a respective receiver module within the gateway proxy server of the virtual application server for the live video stream and establishing the respective logical connection for the live video stream between the respective receiver module for the live video stream and the corresponding network node of the local surveillance domain; and
upon the gateway broker receiving a notification from the local domain controller for any local surveillance domain to which a virtual application server executing within the server pool is allocated specifying that at least one live video stream transmitted by the video sources of the local surveillance domain to the corresponding network node of the local surveillance domain for which a respective logical connection is presently established between a respective receiver module invoked within the gateway proxy server of the virtual application server for the live video stream and the corresponding network node is not presently active, terminating the respective receiver module invoked within the gateway proxy server for each live video stream specified in the notification.

13. The method of claim 12, further comprising, for each live video stream being received from the corresponding network node of each local surveillance domain over the respective logical connection established for the live video stream at the respective receiver module invoked for the live video stream within the virtual application server that is allocated to the local surveillance domain within which the live video stream is captured:
upon the live video stream being relayed from the respective receiver module invoked for the live video stream to the video streaming and processing server implemented within the virtual application server allocated to the local surveillance domain, segmenting the live video stream into a plurality of parts and accessing a streaming video database maintained within a data storage system to record each part of the live video stream in a respective database table created for the live video stream within the streaming video database and associated with the unique identifier of the live video stream, and
wherein the streaming video database is commonly accessed by the plurality of virtual application servers executing within the server pool.

14. The method of claim 13, wherein, upon a first respective receiver module invoked within the gateway proxy server for the virtual application server that is allocated at a first time to any local surveillance domain for receiving any live video stream from the corresponding network node of the local surveillance domain in conjunction with the unique identifier of the live video stream being terminated and, subsequently, a second respective receiver module being invoked within the gateway proxy server for the virtual application server that is allocated at a second time to the local surveillance domain and receiving the live video stream transmitted from the corresponding network node of the local surveillance domain over a respective logical connection established for the live video stream between the second respective receiver module and the corresponding network node in conjunction with the unique identifier of the live video stream, the live video stream being received by the second respective receiver module is segmented into a plurality of parts, and each part of the live video stream being received by the second respective receiver module is, based on the unique identifier of the live video stream, recorded within the respective database table that was created for the live video stream within the streaming video database prior to the first respective receiver module being terminated.

15. The method of claim 13, wherein at least one video source of at least one local surveillance domain is configured to sequentially capture a series of still images and direct transmission of the series of still images to an image processing server over the network, and
wherein the image processing server is configured to, for each series of still images captured by the at least one video source of the at least one local surveillance domain and received by the image processing server, process the series of still images to generate a set of multiple-image time-lapse files for presenting a video sequence of the still images and associated data generated for the series of still images that includes information for displaying a thumbnail image for each time-lapse file and access a time-lapse database maintained within a data storage system to record each time-lapse file generated for the series of still images in a respective database table created for the series of still images within the time-lapse database in conjunction with the associated data generated for the series of still images.

16. The method of claim 13, further comprising commonly providing, at each virtual application server executing within the server pool, a network service that is accessible to a plurality of users through a plurality of client systems communicatively coupled to the virtual application server via the network;
receiving requests from the client systems to establish corresponding client sessions for accessing the network service at a load balancer for the server pool;
determining, according to a scheduling algorithm implemented by the load balancer, a virtual application server of the one or more virtual application servers presently executing within the server pool to allocate to the corresponding client session for each request received by the load balancer; and
establishing, for each request received from the client systems to establish a corresponding client session for accessing the network service, the corresponding client session for the request between the client system from which the request is received and the virtual application server allocated to the corresponding client session.

17. The method of claim 16, further comprising receiving, from one of the client systems being operated by a user to access the network service provided at one of the virtual application servers allocated to a corresponding client session for the client system, a request to view a recording of a specified live video stream of the live video streams that have been transmitted from the corresponding network nodes of the local surveillance domains to respective receiver modules invoked within the virtual application servers allocated to the local surveillance domains for a specified period of time;
accessing the streaming video database via the network service provided at the virtual application server allocated to the corresponding client session for the client system to retrieve each part of the specified live video stream recorded in the respective database table created for the specified live video stream within the streaming video database that corresponds to the specified period of time;
converting each part of the specified live video stream retrieved from the streaming video database into one or more files in a format suitable for playback on the client system; and
transmitting the one or more files to the client system via the connection established between the client system being operated by the user and the virtual application server allocated to the corresponding client session for the client system.

18. The method of claim 16, further comprising receiving, from one of the client systems being operated by a user to access the network service provided at one of the virtual application servers allocated to a corresponding client session for the client system, a request to view a specified live video stream of the live video streams presently being transmitted from the corresponding network nodes of the local surveillance domains to respective receiver modules invoked within the virtual application servers allocated to the local surveillance domains; and
establishing a connection between the client system from which the request to view the specified live video stream is received and the virtual application server allocated to the local surveillance domain that includes the video source capturing the specified live video stream and relaying a copy of the specified live video stream from the video streaming and process server implemented by the virtual application server to the client system via the connection established between the client system and the virtual application server.

19. A system for recording and distributing surveillance data within a networked video surveillance system, the system comprising:
a server pool configured on one or more physical host systems to execute one or more virtual application servers on the one or more physical host systems at any given time; and
a management server comprising an optimization engine configured to dynamically allocate the one or more virtual application servers executing within the server pool to a plurality of local surveillance domains and a gateway broker configured to establish a respective connection between a corresponding network node within each local surveillance domain and the virtual application server allocated to the local surveillance domain over a network, and
wherein each virtual application server executing within the server pool implements a gateway proxy server configured to receive each of one or more live video streams captured by one or more video sources within each local surveillance domain to which the virtual application server is allocated and transmitted from the corresponding network node of the local surveillance domain to the virtual application server via the respective connection between the corresponding network node and the virtual application server.

20. The system of claim 19, wherein each local surveillance domain comprises a local domain controller that is communicatively coupled to the corresponding network node of the local surveillance domain and a plurality of video sources communicatively coupled to the corresponding network node of the local surveillance domain via a local area network for the local surveillance domain, and
wherein the corresponding network node of each local surveillance domain is configured to receive at least one live video stream captured by each of the plurality of video sources of the local surveillance domain and transmitted from the video source to the corresponding network node via the local area network for the local surveillance domain.

21. The system of claim 20, wherein the optimization engine is configured to dynamically allocate the one or more virtual application servers executing within the server pool to the plurality of local surveillance domains by, for each local surveillance domain:
receiving a notification that the gateway broker has received, from the local domain controller of the local surveillance domain, a first request that includes a notification that the corresponding network node of the local surveillance domain has become operative and an indication of a quantity of the video sources of the local surveillance domain that are presently transmitting at least one live video stream to the corresponding network node of the local surveillance domain;
determining whether any of the virtual application servers executing within the server pool has sufficient availability to be allocated to the local surveillance domain based on the quantity of the video sources of the local surveillance domain specified in the first request;
upon determining that at least one of the virtual application servers executing within the server pool has sufficient availability to be allocated to the local surveillance domain, allocating one of the at least one of the virtual application servers to the local surveillance domain;
upon determining that none of the virtual application servers executing within the server pool has sufficient availability to be allocated to the local surveillance domain, invoking an additional virtual application server within the server pool and allocating the additional virtual application server to the local surveillance domain; and
provide an indication of the virtual application server allocated to the local surveillance domain to the gateway broker, and
wherein the gateway broker is configured to, upon receiving each indication of a virtual application server allocated to one of the local surveillance domains from the optimization engine, transmit an acknowledgement message to the local domain controller of the local surveillance domain that specifies the virtual application server allocated to the local surveillance domain.

22. The system of claim 21, wherein the local domain controller of each local surveillance domain is configured to monitor an operating state of the corresponding network node of the local surveillance domain and, in response to detecting that the corresponding network node of the local surveillance domain has become operative, perform a detection of each live video stream presently being transmitted by the video sources of the local surveillance domain to the corresponding network node and generate the first request based on the detection.

23. The system of claim 21, wherein the optimization engine is configured to monitor state and performance information for each of the virtual application servers executing within the server pool, dynamically provision additional virtual application servers for execution within the server pool based on the state and performance information for the virtual application servers and a present demand for virtual application server resources, and dynamically consolidate allocations of virtual application server resources based on the state and performance information for the virtual application servers and the present demand for virtual application server resources, and wherein the optimization engine is configured to, in response to receiving each notification of a first request received by the gateway broker from the local domain controller of any of the local surveillance domains, determine whether any of the virtual application servers executing within the server pool has sufficient availability to be allocated to the local surveillance domain is further based on an analysis of the state and performance information for the virtual application servers executing within the server pool.

24. The system of claim 21, wherein the gateway broker is configured to establish the respective connection between the corresponding network node within each local surveillance domain and the virtual application server allocated to the local surveillance domain by, for each local surveillance domain:
receiving a second request from the local domain controller of the local surveillance domain to establish a respective logical connection over the network between the gateway proxy server of the virtual application server allocated to the local surveillance domain and the local domain controller of the local surveillance domain for each live video stream presently being transmitted by the video sources of the local surveillance domain to the corresponding network node of the local surveillance domain that includes a unique identifier of each live video stream presently being transmitted by the video sources to the corresponding network node;
directing the gateway proxy server of the virtual application server allocated to the local surveillance domain to invoke, based on the second request, a respective receiver module within the gateway proxy server for each live video stream presently being transmitted by the video sources of the local surveillance domain to the corresponding network node of the local surveillance domain; and
directing the gateway proxy server of the virtual application server allocated to the local surveillance domain to establish the respective logical connection for each live video stream presently being transmitted by the video sources of the local surveillance domain to the corresponding network node of the local surveillance domain between the respective receiver module for the live video stream and the corresponding network node of the local surveillance domain.

25. The system of claim 24, wherein the local domain controller of each local surveillance domain is configured to, in response to receiving the acknowledgement message that specifies the virtual application server allocated to the local surveillance domain from the gateway broker, configure a virtual private network (VPN) over the network for communication between the corresponding network node of the local surveillance domain and the gateway proxy server of the virtual application server allocated to the local surveillance domain and generate the second request in reply to the acknowledgement message to include an indication of the VPN,
wherein the gateway proxy server of each virtual application server, to establish the respective connection between the corresponding network node within each local surveillance domain to which the virtual application server is allocated and the virtual application server, establishes the respective logical connection for each live video stream presently being transmitted by the video sources of the local surveillance domain to the corresponding network node over the VPN configured by the local domain controller of the local surveillance domain in accordance with the indication of the VPN included in the second request received by the gateway broker from the local domain controller, and
wherein the corresponding network node of each local surveillance domain is configured to, upon the respective logical connection for each live video stream presently being transmitted by the video sources of the local surveillance domain to the corresponding network node being established, transmit the live video stream over the respective logical connection established for the live video stream in conjunction with the unique identifier of the live video stream to the respective receiver module for the live video stream.

26. The system of claim 24, wherein the gateway proxy server of each virtual application server executing within the server pool is configured to, for each local surveillance domain to which the virtual application server is allocated, monitor the respective logical connection established for each live video stream presently being transmitted by the video sources of the local surveillance domain to the corresponding network node of the local surveillance domain and, upon discovering that the respective logical connection between the respective receiver module for any of the live video streams and the corresponding network node of the local surveillance domain is inactive, attempt to reestablish the respective logical connection for the live video stream and, if unsuccessful in attempting to reestablish the respective logical connection for the live video stream, terminate the respective receiver module for the live video stream and transmit a notification that the respective logical connection is inactive to the local domain controller of the local surveillance domain and to the optimization engine.

27. The system of claim 24, wherein the gateway proxy server of each virtual application server executing within the server pool is configured to, for each local surveillance domain to which the virtual application server is allocated, monitor the respective connection between the corresponding network node of the local surveillance domain and the virtual application server and, upon discovering that the respective connection is inactive, attempt to reestablish the respective logical connection and, if unsuccessful in attempting to reestablish the respective connection, terminate the respective receiver module invoked within the gateway proxy server for each live video stream transmitted by the video sources of the local surveillance domain to the corresponding network node and transmit a notification that the respective connection is inactive to the optimization engine.

28. The system of claim 24, wherein the gateway proxy server of each virtual application server executing within the server pools is configured to receive one or more live video streams captured by one or more video sources within each local surveillance domain to which the virtual application server is allocated, by, for each local surveillance domain to which the virtual application server is allocated:
receiving, at the respective receiver module for each live video stream presently being transmitted by the video sources of the local surveillance domain to the corresponding network node of the local surveillance domain, the live video stream transmitted from the corresponding network node over the respective logical connection established for the live video stream in conjunction with the unique identifier of the live video stream; and
relaying each live video stream received from the corresponding network node of the local surveillance domain in conjunction with the unique identifier of the live video stream from the respective receiver module for the live video stream to a video streaming and processing server implemented within the virtual application server allocated to the local surveillance domain.

29. The system of claim 28, wherein the local domain controller for each local surveillance domain is configured to:
upon the respective connection between the corresponding network node of the local surveillance domain and the virtual application server allocated to the local surveillance domain being established, monitor the video sources of the local surveillance domain;
upon detecting any video source of the local surveillance domain connecting to the corresponding network node of the local surveillance domain to transmit a live video stream for which a respective logical connection between the gateway proxy server of the virtual application server allocated to the local surveillance domain and the local domain controller is not presently established, transmit a request to the gateway broker to establish a respective logical connection over the network between the gateway proxy server of the virtual application server allocated to the local surveillance domain and the local domain controller for the live video stream that includes a unique identifier of the live video stream; and
upon detecting a connection between the corresponding network node of the local surveillance domain and any video source of the local surveillance domain transmitting at least one live video stream to the corresponding network node for which a respective logical connection between the gateway proxy server of the virtual application server allocated to the local surveillance domain and the local domain controller is presently established becoming inactive, transmit a notification to the gateway broker that each live video stream being captured by the video source for which a respective logical connection is presently established is not presently active.

30. The system of claim 29, wherein the gateway broker is configured to:
upon receiving a request from the local domain controller for any local surveillance domain to which a virtual application server executing within the server pool is allocated to establish a respective logical connection over the network between the gateway proxy server of the virtual application server and the local domain controller for a live video stream being transmitted by any video source of the local surveillance domain to the corresponding network node of the local surveillance domain for which a respective logical connection between the gateway proxy server of the virtual application server and the local domain controller is not presently established, direct the gateway proxy server of the virtual application server allocated to the local surveillance domain to invoke, based on the request, a respective receiver module within the gateway proxy server for the live video stream and establish the respective logical connection for the live video stream between the respective receiver module for the live video stream and the corresponding network node of the local surveillance domain; and
upon receiving a notification from the local domain controller for any local surveillance domain to which a virtual application server executing within the server pool is allocated specifying that at least one live video stream transmitted by the video sources of the local surveillance domain to the corresponding network node of the local surveillance domain for which a respective logical connection is presently established between a respective receiver module invoked within the gateway proxy server of the virtual application server for the live video stream and the corresponding network node is not presently active, direct the gateway proxy server of the virtual application server allocated to the local surveillance domain to terminate the respective receiver module invoked within the gateway proxy server for each live video stream specified in the notification.

31. The system of claim 30, wherein, for each live video stream being received from the corresponding network node of each local surveillance domain over the respective logical connection established for the live video stream at the respective receiver module invoked for the live video stream within the virtual application server that is allocated to the local surveillance domain within which the live video stream is captured, upon the live video stream being relayed from the respective receiver module invoked for the live video stream to the video streaming and processing server implemented within the virtual application server allocated to the local surveillance domain, the video streaming and processing server implemented within the virtual application server allocated to the local surveillance domain operates to segment the live video stream into a plurality of parts and access a streaming video database maintained within a data storage system to record each part of the live video stream in a respective database table created for the live video stream within the streaming video database and associated with the unique identifier of the live video stream, and
wherein the streaming video database is commonly accessed by the plurality of virtual application servers executing within the server pool.

32. The system of claim 31, wherein, upon a first respective receiver module invoked within the gateway proxy server for the virtual application server that is allocated at a first time to any local surveillance domain for receiving any live video stream from the corresponding network node of the local surveillance domain in conjunction with the unique identifier of the live video stream being terminated and, subsequently, a second respective receiver module being invoked within the gateway proxy server for the virtual application server that is allocated at a second time to the local surveillance domain and receiving the live video stream transmitted from the corresponding network node of the local surveillance domain over a respective logical connection established for the live video stream between the second respective receiver module and the corresponding network node in conjunction with the unique identifier of the live video stream, the video streaming and processing server implemented within the virtual application server that is allocated at the second time to the local surveillance domain operates to segment the live video stream being received by the second respective receiver module into a plurality of parts, and access a streaming video database to record each part of the live video stream being received by the second respective receiver module, based on the unique identifier of the live video stream, within the respective database table that was created for the live video stream within the streaming video database prior to the first respective receiver module being terminated.

33. The system of claim 31, wherein at least one video source of at least one local surveillance domain is configured to sequentially capture a series of still images and direct transmission of the series of still images to an image processing server over the network, and
wherein the image processing server is configured to, for each series of still images captured by the at least one video source of the at least one local surveillance domain and received by the image processing server, process the series of still images to generate a set of multiple-image time-lapse files for presenting a video sequence of the still images and associated data generated for the series of still images that includes information for displaying a thumbnail image for each time-lapse file and access a time-lapse database maintained within a data storage system to record each time-lapse file generated for the series of still images in a respective database table created for the series of still images within the time-lapse database in conjunction with the associated data generated for the series of still images.

34. The system of claim 31, wherein each virtual application server executing within the server pool is configured to provide a network service that is accessible to a plurality of users through a plurality of client systems communicatively coupled to the virtual application server via the network, and
wherein the management server further comprises a load balancer for the server pool that is configured to receive requests from the client systems to establish corresponding client sessions for accessing the network service, determine, according to a scheduling algorithm implemented by the load balancer, a virtual application server of the one or more virtual application servers presently executing within the server pool to allocate to the corresponding client session for each request received by the load balancer, and direct, for each request received from the client systems to establish a corresponding client session for accessing the network service, the client system from which the request is received to establish the corresponding client session for the request between the client system and the virtual application server allocated to the corresponding client session.

35. The system of claim 34, wherein, upon one of the virtual application servers allocated to a corresponding client session for one of the client systems receiving, from the client system being operated by a user to access the network service provided at the virtual application server allocated to the corresponding client session, a request to view a recording of a specified live video stream of the live video streams that have been transmitted from the corresponding network nodes of the local surveillance domains to respective receiver modules invoked within the virtual application servers allocated to the local surveillance domains for a specified period of time, the virtual application server allocated to the corresponding client session operates to access the streaming video database to retrieve each part of the specified live video stream recorded in the respective database table created for the specified live video stream within the streaming video database that corresponds to the specified period of time, convert each part of the specified live video stream retrieved from the streaming video database into one or more files in a format suitable for playback on the client system, and transmit the one or more files to the client system via the connection established between the client system being operated by the user and the virtual application server.

36. The system of claim 34, wherein, upon one of the virtual application servers allocated to a corresponding client session for one of the client systems receiving, from the client system being operated by a user to access the network service provided at the virtual application server allocated to the corresponding client session, a request to view a specified live video stream of the live video streams presently being transmitted from the corresponding network nodes of the local surveillance domains to respective receiver modules invoked within the virtual application servers allocated to the local surveillance domains, the virtual application server allocated to the corresponding client session operates to direct the client system from which the request to view the specified live video stream is received to establish a connection between the client system and the virtual application server allocated to the local surveillance domain that includes the video source capturing the specified live video stream, and the virtual application server allocated to the local surveillance domain that includes the video source capturing the specified live video stream operates to, in response to the connection being established, relay a copy of the specified live video stream from the video streaming and process server implemented by the virtual application server to the client system via the connection.

37. A computer apparatus, comprising:
a processor, and a memory storing computer readable instructions for execution by the processor to perform a method for recording and distributing surveillance data within a networked video surveillance system, and wherein the method comprises:
dynamically allocating one or more virtual application servers executing within a server pool on one or more physical host systems to a plurality of local surveillance domains; and
establishing a respective connection between a corresponding network node within each local surveillance domain and the virtual application server allocated to the local surveillance domain over a network such that the virtual application server is operable to receive one or more live video streams captured by one or more video sources within the local surveillance domain and transmitted from the corresponding network node of the local surveillance domain via the respective connection.
